(19) United States
(12) Patent Application Publication
(10) Pub. No.: US 2014/0195463 A1
(43) Pub. Date: Jul. 10, 2014

(54) SYSTEM AND METHODS FOR GENERATING AND DISPLAYING OPTIMIZED SOLUTIONS TO COMPLEX PROBLEMS

(71) Applicant: Jonathan S. Jacobs, New York, NY (US)

(72) Inventor: Jonathan S. Jacobs, New York, NY (US)

(21) Appl. No.: 14/152,760

(22) Filed: Jan. 10, 2014

Related U.S. Application Data
(60) Provisional application No. 61/750,923, filed on Jan. 10, 2013.

(51) Int. Cl. G06N 5/04

(52) U.S. Cl. CPC G06N 5/04
USPC 706/11; 706/50; 706/46

(57) ABSTRACT

The aspects of the disclosed embodiments are directed to a method executed in a computer-based system using a processor with memory that includes modeling and representing complex problems in memory according to the mechanisms detailed herein, applying information about and/or soliciting information from end-users, and applying the models and expressions of these problems to configure and thereby transform a system in memory to a system capable of efficiently creating and delivering optimized solutions.

### CROSS-REFERENCE TO RELATED APPLICATIONS

This application claims priority to and the benefit of, U.S. Provisional Patent Application Ser. No. 61/750,923, filed on Jan. 10, 2013, the disclosure of which is incorporated herein by reference in its entirety.

### FIELD

Aspects of the disclosed embodiments generally relate to systems and methods for modeling complex problems, developing, generating and displaying optimized solutions to complex problems. More specifically, this disclosure relates to systems and methods for modeling and generating optimized solutions to complex problems which may involve, among other mechanisms, expert modules based on relationships and interactions between assets, the inherent qualities of these assets, end-user needs, the inherent qualities of end-users, and a connector-based and asset-based lexicography.

### BACKGROUND

The Internet is often used as an information research tool to help people find solutions to real-world problems and get answers to their questions. These problems and questions can be almost anything, such as: trying to determine what area in which to purchase a home and which specific home to purchase; consumer related problems of trying to determine which of a specific type of product to purchase (e.g. which specific TV to buy) or from which source to purchase a particular product or service; compatibility problems of which product will work best with other products a person already owns; problems of how to do something based on certain personal factors, etc. There are seemingly unlimited numbers and types of problems that people use the Internet to help solve. There is also a seemingly unlimited amount of information available online that can help an individual arrive at a solution. However, the information is often widely spread out, unorganized, and not easily identified or properly used, because no practical, effective tool may exist to apply the information to specific problems.

End users often use traditional search engines to research information, goods and services, or available options, make decisions, comparison shop and/or make purchases. These exercises, with time and patience to spare, can be done using existing web-based resources. Indeed, these exercises were all previously done, in a similar manner, prior to the existence of the Internet.

Traditional Internet or web search engines (e.g. Google™, Yahoo™, Bing™) are designed to search for and find information on the Internet based on a search query or keywords/terms that are input by an end-user. When a search is run in a traditional search engine, the information returned is normally presented as a list of results or “hits” that is generally based on the perceived relevance to the searched term or phrase. The results that are considered by the search engine to be the most relevant to the end user's search term(s) are typically located at the top of the list, with decreasing relevance the further down the list a result is located. Often, the hits that are presented at the top of the results list are links to web pages that contain the same words as the search phrase, or specific web pages that have been historically selected more often by other end-users when similar searches have been run in the past. The results may consist of links to web pages, images, documents and other types of files and information in various formats. However, the results returned from a traditional search engine are not necessarily based on actual relevance to the end-user and still leave the end-user with the arduous task of evaluating the results, a task for which they may not be qualified, to see if the results are actually relevant to what the user was searching for, or represent actual solutions. This makes the task of using the results to solve the individual's problem very tedious. In addition, decisions may be made based solely on the search results the individual user has taken the time to review and evaluate, having only limited specific expertise. Therefore, the decisions may not be based on all the relevant information available and may not therefore be the “best” solution to a problem, particularly one for which subject matter expertise is required.

Furthermore, as a “solution” resource, traditional search engine models suffer four additional fundamental limitations. First, traditional search engines are weak-context services. There is generally very little or no context, or “situation-specific awareness,” for searches run with traditional search engines. Except for the string of text inputted by the end-user, the search engine does not know the context of the search requested, or the precise needs of end users (i.e. the end user's context), because the limits inherent in keyword-based searches practically prohibit this. Consequently, search engines acquire, index, and point to information about things, but such information only helps direct users to possible answers. Search engine responses represent possible answers, or information about possible answers, but almost never do they definitively specify the answer itself.

Second, the resulting data that is returned following a search performed using a traditional search engine lacks detail and is usually incomplete. The full-text indexing mechanism of traditional search engines offers no practical mechanism to fully-regard the internal characteristics of a sought item; full-text can only locate an item by name, or whatever other text might be associated with it in an unstructured manner. For example, if an end-user wants to buy a snow blower, a full-text search for “snow blowers” will return results relating to web-pages about snow blowers. However, it is likely that none of the search results themselves, nor any resulting associated web-page, convey the comprehensive, specific, relevant information about the item (e.g. specifications such as cost, size, weight, gas-or-electric, snow capacity (depth and forward speed), throw distance, throw height, noise level, mount options, accessories, power, ease-of-use, etc.) that may be, or should be, important to the end-user. Such information is required for end-user evaluation and subsequent purchase decisions. No such comprehensive detail is available in a practical way to full-text search engines. If the end-user wants this information, he usually must continue digging for it after a search is run rather than it being a part of the actual search results.

Third, there is a lack of organization to both the data that is available for Internet searching, and the data that is returned as the results of traditional search engine searches. When traditional full-text search engines search through information available online to return search results, the content information searched on a typical web page is essentially unstructured, especially as compared to information contained in traditional databases. The information searched generally has little-or-no consistent structure relating to topic/content detail, and any structure present relates to HTML formatting (i.e. a web-page) so that the page may be conveniently viewed using a web browser. This means that item-related specifications, even when they are present, cannot reliably be identified or considered by the search engine in determining which results to return. Using a snow-blower again as an example, even if the phrase “15 amps” is present on a given web-page, it is generally impractical for the search engine to determine whether this refers to engine current draw (e.g. a snow-blower having a 15 amp engine), or A.C. circuit requirements (e.g. the required current capacity of the necessary outlet). Important meta-specification considerations, like “measure” (e.g. volume, mass, weight, and length), “scale” (e.g. a multiple of tens, thousands, millions), and “system” (e.g. metric, imperial) for example, are inconsistent among web pages. The same commonly used word(s) and phrases may represent different things. Without a practical mechanism to effectively identify and rationalize specifications, there is no way for a search engine, or any other similar system, to identify and locate relevant information and help an end-user make useful decisions about the items he is searching for.

Fourth, the traditional search engine approach is too simplistic to represent, let alone solve, problems requiring any form of abstraction. The traditional search engine model is a “pattern-matching” system (e.g. the end-user is saying “I seek occurrences of this word or phrase.”). The traditional search engine finds occurrences of the word or phrase on web pages published to the Internet and returns them to the end-user as results. There are no practical comprehensive mechanisms for any higher-level concepts or expressions, such as “better/worse,” suitability, compatibility, even basic quantitative and qualitative characteristics. It is possible to achieve some of these things, with limited success, using endless strung-together terms in a full-text search engine. However, the underlying mechanism is still pattern-matching.

There are also existing web sites on the Internet that purport to be “expert” web sites (e.g. www.chacha.com, www.quora.com, www.findthebest.com, www.sortable.com, and continuing initiatives by Google™ and Facebook™) where end users can submit questions on a wide variety of topics and receive answers. While each site's approach is slightly different, all of these “expert” web sites suffer from one or more of the following limitations and deficiencies.

Many of these expert web sites have a limited scope of “solution” they can offer, and most of the existing resources are not truly effective for solving any problem. Most questions and/or problems individuals have are complex, regardless of the question or problem. All decisions involve the weighing of multiple Criteria, whether or not the person making the decision knows they are weighing Criteria. Even for the simplest of decisions, like where to eat for lunch, an individual weighs various multiple Criteria, like what type of food to eat, whether to get food at a sit down restaurant or a takeout place, how far is he willing to travel, how much is he willing to spend, etc. While the weighing of Criteria may be made quickly and/or subconsciously, it is still being done with every decision an individual makes. However, most existing expert web sites are geared towards using simple models to provide simple solutions to simple problems, or to answer a simple question. While the end user may receive an answer to a posed question or a solution to a posed problem, the answer or solution is, at best, also usually limited in scope. Consequently, existing expert web sites are not very effective for solving any problem or answering any question, let alone truly complex problems or complex questions.

In addition, if it is a problem that is posed, the expert sites essentially provide advice to the individual, which is not likely a “best” solution based on the specific individual-weighting of multiple criteria. Moreover, these types of websites are providing answers or solutions based on a limited database of available information, and/or the human expertise of only the people who are employed by the specific web site. Because the existing “expert” sites are limited to simple problem/questions models, solutions, advice, and do not factor in considerations that are personal to the specific end user, these type of sites ultimately cannot provide a “best solution” to a given problem for that specific end user.

Furthermore, existing expert web sites consider a very limited number of criteria in arriving at an answer or solution to a problem or question that is posed. The “best” solution reflects an all-inclusive consideration of all relevant points. It is again impractical for the “advice” provided by existing expert sites to reflect, for all possibilities, all potentially relevant points. Typically, existing expert web sites take into account only the specific criteria that are posed in the question itself, rather than considering all of the relevant criteria that will likely affect the solution provided.

In addition, existing expert sites provide limited, if any, criteria guidance as to which criteria should be more or less important to which specific end-users (e.g. “What if I′m a student instead of a retiree who just wants to read periodicals? How important is it to have an 8 Gb, rather than 80 Gb, hard drive on my laptop? Should I care? How much should this be worth to me?”). Merely presenting relevant criteria is helpful, but hardly assures an optimal solution. Not all criteria under consideration are of identical importance to a given end-user, and a given end-user will not necessarily assign the same weighted importance level to the criteria under consideration as another end-user. None of this is usually factored into solutions, or “advice,” provided by existing expert-sites. Even with the expert web sites that, to some extent, can account for various additional criteria beyond those posed in the question/problem, they essentially only act as a filter and are unable to account for the varying levels of importance attributed to each criteria by different end-users.

Moreover, existing expert sites can only provide a limited definition of what is “best” for an end-user. Because competitive sites are unable to provide accurate and unbiased determinations as to “what is best” based on specific end-user needs and circumstances, importance of various criteria ends up being determined exclusively by the opinions of other parties. This may be relevant, but may also be irrelevant, based on the identity and needs of the specific end-user. Even a “weighted average” of opinions from other resources reflects, by design, only a general consensus with no correlation to the specific end-user or his/her needs.

Lastly, existing expert sites operate with limited databases and/or expertise. No resource, be it a website or individual, can claim mastery of all topics. Unless it can claim, with reasonable basis, to effectively reflect the expertise of every party with a legitimate claim to mastery, arguably, no single resource can represent itself as “the best authority” on anything.

Accordingly, while an end-user utilizing an existing “expert site” may eventually arrive at some form of solution to his problem, the solution will likely not be the best solution available due to the aforementioned limitations.

In addition to traditional search engines and existing “expert” sites, several different product/service search and price-comparison web sites and engines (e.g. eBay.com, Amazon.com, etc.) are available. However, they simply use technology to speed up traditional approaches to shopping for products/services, and accordingly have significant limitations. For example, eBay and other portals offer basic filtering tools for the selection of goods/services, but they lack solution-oriented sophistication and remain, for now, “portals for goods” rather than sites selling goods as solutions to complex problems. Accordingly, while these engines are broad-market in scope, they are inefficient/ineffective as “solution tools.”

“Platform ecosystems” such as Android Market and the Apple and Microsoft App Stores offer a consumer marketplace and frameworks to support both transaction processing (e.g. purchasing) and technical capabilities (e.g. UI, data storage, communications and processing support). However, creating useful, commercially viable, and/or moderately complex applications suitable for such platforms still requires substantial technical expertise and resources. Moreover, resources such as Microsoft Siena and LightSwitch are constrained by the limits of the rapid application design (“RAD”) nature; once these limits are exceeded, traditional methods, languages and tools are required. Finally, no provisions are offered for dynamically sharing application development challenges. Accordingly, such end-user-oriented platform ecosystems are unsuitable for the creation of useful, commercial, complex applications by comparatively non-technical users.

Almost every business, particularly those of significant size, in order to remain competitive, has some form of business and/or market-specific systems which seek to help maximize the profitability of the business by suggesting strategies and tactics to maximize the efficiency of critical processes. However, such systems are invariably either highly generalized and/or, if business/process-specific, demanding of substantial technical resources for development, initial configuration and continued evolution. Consequently, customized, operation-specific systems capable of, for example, optimizing the allocation of resources and maximizing profitability are expensive to develop and maintain, and are the near-exclusive domain of larger enterprises with substantial financial resources.

Accordingly, there is a need for a broad-scope, platform-based system for generating optimized (i.e. the “best possible”) solutions to complex problems. There is a further need for a system that takes into account personal criteria of the specific end-user, allows that end-user to apply varying levels of weighted importance to each identified criteria, and utilizes the personal criteria information to generate the optimized solution to that specific problem.

### SUMMARY

Disclosed herein are systems and methods, including computer software, for generating and displaying optimized solutions to a broad range of problems, wherein the optimized solutions may include the identification, suggested allocation, and/or application of one or more “Assets,” as that term is generally defined herein, as part, or all, of the solution to the problem. Assets, as that term is generally referred to herein, is intended to include real-world goods, services, places, methods, etc., non-existent or pre-real-world-existent goods, services, places, methods, etc. which are anticipated to exist in the future, and formatted data such as pictures, movie, audio, video etc. that are often (but not always) offered for sale. In determining the optimized solutions to the problems of a given end-user, the system is able to factor in numerous “Criteria” and personal preferences that must be taken into consideration, and which will affect the optimized solution generated by the system for that specific end-user. Criteria are the specifications, characteristics, or measures of various qualities (either physical or more abstract) associated with, among other things, the Assets (i.e. Asset-Criteria), the manufacturer or provider of Assets (i.e. Provider-Criteria), end-users (i.e. Profile-Criteria), etc., that an end-user may want considered in the determination of an optimal solution to a problem.

According to an embodiment of the present disclosure, a system is presented for generating one or more optimal solutions to an end-user's search or problem, the system comprising at least a system platform allowing the end-user to interface with the system, one or more Expert-modules or engines that may, among other mechanisms, define and specify a set of rules and relationships that represent and encompass at least the Author's expertise and knowledge in one or more various subject areas or topics, a Solution-Engine configured to analyze information and formatted data passed to it by the Expert-module and generate optimized solutions, and a Database containing information on currently available Assets, one or more of which Assets may be returned as part of the optimized solution to the problem.

In another embodiment, the platform is a web-based platform in which the end-user may access the system via the Internet through a web browser.

In another embodiment, the platform is a “native client”-based platform in which the end-user may access the system via system resources other than a web browser.

In another embodiment, each Expert-Program module at least comprises computer-readable instructions and programming that are configured to be executed by one or more computers or processors and that are configured to apply logic including modeled relationships between Assets based on the Criteria (characteristics) associated with those Assets. In an additional embodiment, each Expert-Program module further comprises computer-readable and executable programming and instructions that are configured to model relationships between Assets and end-users, based on the Criteria associated with both the Assets and end-users.

In yet another embodiment the Solution Engine comprises computer readable instructions and complex programming, that when executed by a computer or processor are configured to take the Author-programmed logic and relationship information as well as any end-user inputted data from the Expert-Program modules, and applies the appropriate rules to properly analyze that information, in order to generate one or more optimized solutions to the problem.

In yet another embodiment, each Expert-Program module may comprise one or more sections called Blocks, representing discreet pieces of knowledge to be used by the Expert-Program modules.

In yet another embodiment, each Expert-Program module may comprise one or more sets of Defaults, which include default target values for various Criteria, as well as an associated importance value for that Criteria and its target value in relation to the other Criteria that are being considered in the determination of a solution to the end-user's problem. Defaults, as set by the Expert-Program modules according to the terms specified by the Author, represent specific target and importance values for the Expert-Program modules to use as suggested starting points in the determination of what Criteria an end-user wants in a solution, the target value that the Criteria should ideally have, and how important that Criteria and its target value are in the determination of an overall solution to the problem. Defaults may be static values selected by an Author or a dynamic set of rules that enable the Expert-Program modules to determine appropriate default values for one or more Criteria.

In yet another embodiment, each Expert-Program module can incorporate expressions representing connectivity, which detail how Assets may relate to each other via Criteria which may be interconnected. In one embodiment, expressions of connectivity may include Interfaces, Connectors comprised of Interfaces, Connector groups comprised of groups of Connectors, and Connections which may be satisfied via Connectors, or Connector groups.

In yet another embodiment, each Expert-Program module can comprise programming that includes a model of relationships among Assets and end-users, according to rules governing the associated Criteria (i.e. characteristics) of the Assets and end-users. In one embodiment of this relationship model, these rules are organized hierarchically, including the specification of hierarchical levels of Interfaces, Connectors and Connector groups, and Connections, each of which are both associated with Criteria and detail how Criteria relate to each other. In alternate embodiments, the hierarchical model of the nature of the relationships between Criteria of Assets (and other Criteria associated with end-users, providers, etc.) may be expressed by different terms and with different numbers of hierarchical levels without departing from the spirit and intent of the disclosure herein.

In yet another embodiment, each Expert-Program module can incorporate expressions and data elements further refining this relationship model, including data elements representing Affinity as a specification of “selective attractive force” among objects, and Aversion as a specification of “selective repulsive force” among objects.

In yet another embodiment, Expert-Program modules may incorporate expressions including connectivity, primacy, and affinity/aversion as defined herein, thereby resulting in the effective expression of compatibility, which may not otherwise need to be more explicitly or directly represented.

In yet another embodiment, the Database comprises at least an information and data storing structure, such as a memory structure, for storing the data elements and other information related to Assets (i.e. Asset-Criteria and the associated values of those Criteria). In another embodiment, the Database further comprises a separate structure for storing data elements and information relating to end-users (i.e. Profile-Criteria and the associated values of those Criteria). In yet another embodiment, the Database further comprises separate information and data storing structures for storing information related to each of Original Equipment Manufacturers (OEMs), Original Service Providers (OSPs), additional providers of Assets, and market research data. For purposes of the description herein, the Database can comprise part of the system or be coupled to the system.

According to an embodiment of the present disclosure, a method is presented for generating one or more optimal solutions to an end-user's problem, the method comprising modeling an Author's subject-matter expertise, wherein modeling expertise may comprise, among other aspects, identifying Criteria that are relevant to the problem and defining a hierarchical relationship model to specify the relationships among the Assets relevant to those Criteria; collecting information from an end-user related to the end-user's specific problem-to-be-solved when such information is otherwise unavailable; analyzing the end-user information by at least correlating it against the relevant Assets and the defined hierarchical relationships and/or supporting logic that were modeled by the Author; applying at least the relationship model to the relevant Assets; forming groups representing viable Solutions; and generating one or more optimized solutions to the end-user's problem based on the correlation of the information obtained from (or on behalf of) the end-user as well as the relevant Criteria identified by the Author, the respective importance of these Criteria as identified or affirmed by the Author, and the application of the relationship model and/or supporting logic defined by the Author.

In another embodiment, the method further comprises specifying the importance of individual Criteria and specifying Default information prior to analyzing the end-user information.

These and other aspects and advantages will become apparent to those of ordinary skill in the art by reading the following detailed description, with reference where appropriate to the accompanying drawings. Further, it should be understood that the foregoing summary is merely illustrative and is not intended to limit in any manner the scope or range of equivalents to which the appended claims are lawfully entitled.

### BRIEF DESCRIPTION OF THE DRAWINGS

The aspects of the disclosed embodiments are generally described in detail below with reference to the attached drawing figures, wherein:

FIG. 1 is block diagram of one embodiment of the system, representing subsystem and party “objects.”

FIG. 2 is a flowchart depicting an embodiment of general system operation.

FIG. 3 is a graphic illustration depicting exemplary problem/challenge types, according to an embodiment disclosed herein.

FIG. 4 is an exemplary flowchart depicting an embodiment of the Author process for writing an Expert-Program module, according to an embodiment disclosed herein.

FIG. 5 is an exemplary depiction of an embodiment of the connectivity hierarchy for modeling and programming Expert-Program modules, according to an embodiment disclosed herein.

FIG. 6 is an exemplary flowchart illustrating the use of multiple called Blocks in an Expert-Program module, according to an embodiment disclosed herein.

FIG. 7 is an exemplary flowchart depicting the functional relationship and operation between an Expert-Program module and called Blocks, according to an embodiment disclosed herein.

FIG. 8 illustrates exemplary records within an Asset Collection in a system incorporating aspects of the present disclosure.

FIG. 9 is an exemplary flowchart depicting an embodiment of the process steps taken by an end-user to utilize a system incorporating aspects of the present disclosure.

FIG. 10 illustrates exemplary “pre-process” flow in one embodiment of a system incorporating aspects of the disclosed embodiments.

FIG. 11 illustrates an exemplary real-time and “post-process” flow in one embodiment of a system incorporating aspects of the disclosed embodiments.

FIG. 12 illustrates an exemplary “Solver” process flow of the Solution engine in one embodiment of a system incorporating aspects of the disclosed embodiments

FIG. 13 is a screenshot depicting an embodiment of the system's Login and “basic search” screen, according to an embodiment disclosed herein.

FIG. 14 is a screenshot depicting an embodiment of the system's Expert-Program module “advanced search” screen, according to an embodiment disclosed herein

FIG. 15 is a screenshot depicting an embodiment of the system's Home screen, according to an embodiment disclosed herein.

FIG. 16 is an exemplary screenshot depicting an embodiment of an Expert-Program module Search Results detail screen, following an intermediate end-user's search for an Expert-Program module to design a home theater, according to an embodiment disclosed herein.

FIGS. 17-20 are exemplary screenshots depicting embodiments of many possible end-user input screens associated with an Expert-Program module being run by an end-user, according to an embodiment disclosed herein.

FIG. 21 is an exemplary screenshot depicting an embodiment of a Solution screen that has been generated after information from the Expert-Program module has been passed to, and analyzed by, the Solution Engine, according to an embodiment disclosed herein.

FIG. 22 is a flowchart illustrating an exemplary process through which resources may be identified and allocated optimally over time.

### DETAILED DESCRIPTION

While the present disclosure is capable of being embodied in various forms, for simplicity and illustrative purposes, the principles of the disclosure are described by referring to several embodiments thereof. It is understood, however, that the present disclosure is to be considered as an exemplification of the claimed subject matter, and is not intended to limit the appended claims to the specific embodiments illustrated. It will be apparent to one of ordinary skill in the art that the disclosure may be practiced without limitation to these specific details. In other instances, well-known methods and structures have not been described in detail so as not to unnecessarily obscure the present disclosure.

The aspects of the disclosed embodiments are directed to a social Solution platform and tool that is configured to solve complex problems. While traditional search engines are focused on finding unstructured information across the Internet, or World Wide Web, and existing “expert” sites offer limited expertise (or simple “filtering”) for a relatively small number and type of conditions, the aspects of the disclosed embodiments provide a new class of Internet web-driven application that leverages human expertise and insight with internal data and powerful algorithms and can provide the best possible solutions for common problems.

In general, the systems and methods described below allow an individual user of the system (an “end-user” who may also potentially represent the interests of other parties) to request, generate and display optimized solutions to a broad range of problems, wherein the optimized solutions include at least the identification of one or more “Assets” as part, or all, of the solution to the problem. As will be discussed in further detail below, Assets generally include real-world goods, services, places, methods, etc., or formatted data such as pictures, movie, audio, video etc. that are often (but not always) offered for sale. In determining the optimized solutions to the problems of a given end-user, the system is able to factor in numerous “Criteria” and personal preferences that must be taken into consideration, and which will affect the optimized solution generated by the system for that specific end-user. Again, as will be discussed in further detail below, Criteria are the specifications, characteristics, or measures of various qualities (either physical or more abstract), in the form of data elements, associated with, among other things, the Assets (i.e. Asset-Criteria), the manufacturer or provider of Assets (i.e. Provider-Criteria), end-users (i.e. Profile-Criteria), etc., that an end-user may want considered in the determination of an optimal solution to a problem.

As referenced herein, “criteria” refers generically to “a characteristic of” In one embodiment, Asset-Criteria may directly correlate with the specifications associated with specific Assets. In another embodiment, as when an Expert-program solicits end-user preferences, criteria refers to a characteristic of the problem modeled by the Expert-program. Such expressions of end-user preference may subsequently be translated by the Expert-program and/or Solution-Engine to correlate more directly with Asset-criteria.

To help arrive at an optimized solution to an end-user's problem, the end-user can specify target values for Asset-Criteria and other related Criteria, based on the end-user's specific needs. In addition, the system allows the end-user to apply weighted importance values to each of the Criteria under consideration, which represent the level of importance that the end-user places on each identified Criteria; the end-user's preferences. In this regard, two individuals having the identical problem to be solved, identical target values of the identified Criteria that need to be factored in, but different weighted importance values for each of those Criteria, indicating differing preferences, could easily arrive at different optimized solutions.

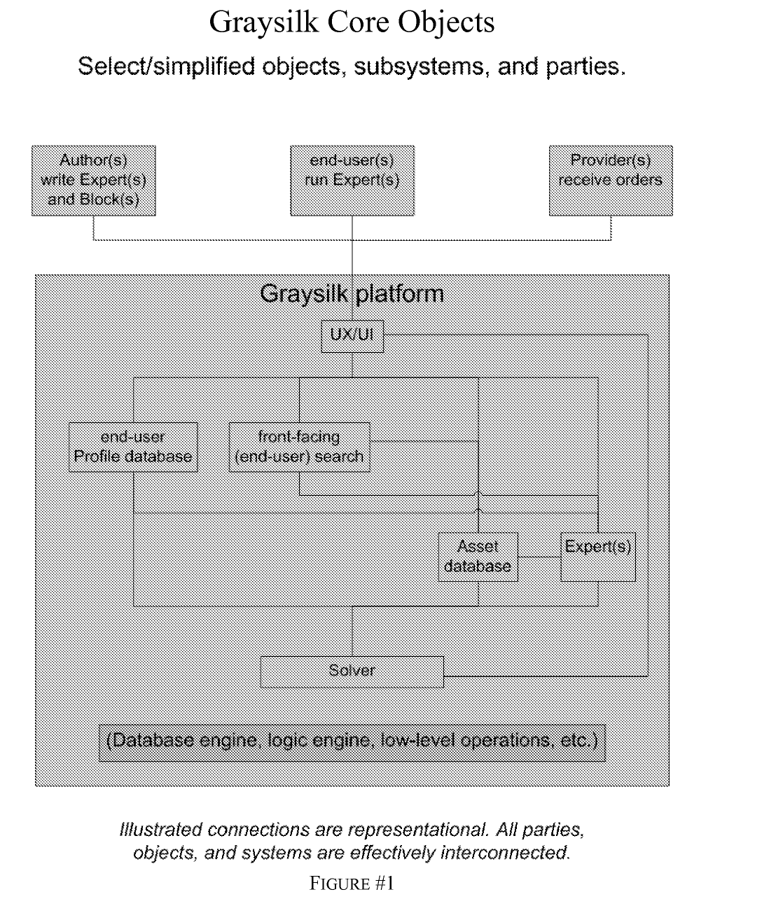

Referring to FIG. 1, in one embodiment, the system comprises at least: (1) a system platform; (2) one or more executable programs, called “Experts” or Expert-Program modules, that can be executed by the system platform and which contain a set of rules and relationships representing varying aspects and levels of human expertise in various subject areas; (3) a Solution-Engine, or solver which is a platform-based module capable of interfacing with the Expert-Program modules in order to generate and return an optimized solution(s) to a given problem; and (4) at least a “Database” for storing information on all available Assets, one or more of which are returned as part of the optimized solution.

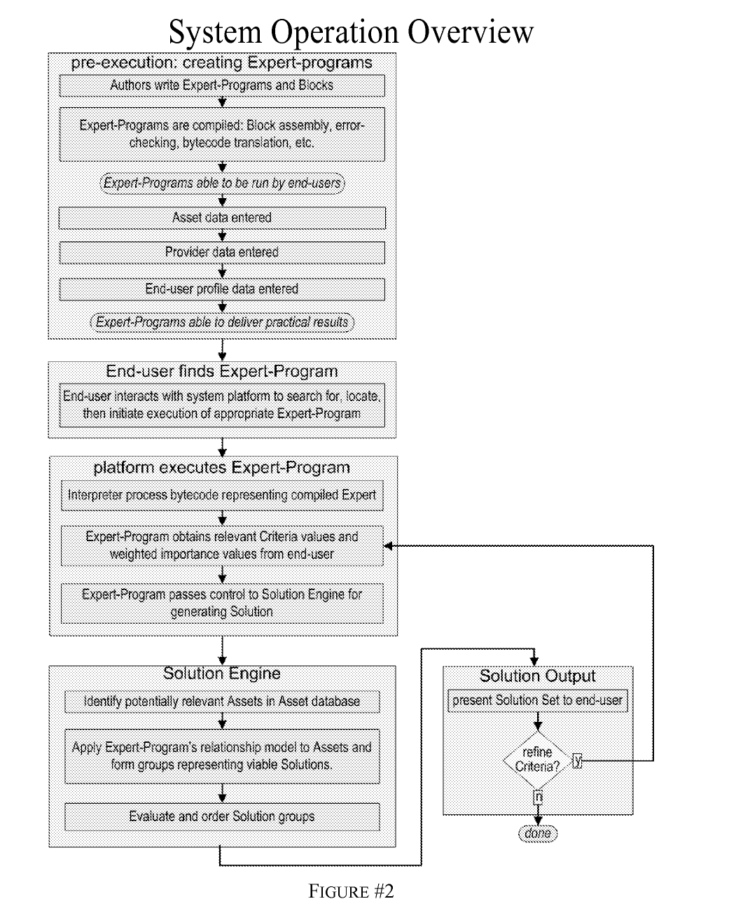

FIG. 2 illustrates a flowchart illustrating one embodiment of the operation of a system incorporating aspects of the present disclosure. In this example, the Authors develop the Expert-Program modules and Blocks. The Experts are compiled and run by end users. The Asset data is entered or loaded into the Asset database, as well as any Provider data.

In one embodiment, to use the system, the end-user interfaces with the platform to search for and select an Expert-Program module that corresponds to the topic/subject-area of the problem to be solved. One example of an Expert-Program module might be a “Home Theater Expert” for helping an end-user purchase a home theater system. The system platform locates the end-user selected Expert-Program modules, or in an alternate embodiment, an Expert-Program module which the platform has identified as being the most appropriate for addressing the problem. The system platform then executes the selected Expert-Program module, and the end-user inputs information related to the specific Criteria identified by the Expert-Program module that are relevant to the problem-to-be-solved.

In one embodiment, the information entered by the end-user may include the end-user's preferred target values for each of the Criteria identified by the Expert-Program modules. For example, if an end-user is running the Home Theater Expert-Program modules, one Criteria relating to the Asset “stereo receivers” might be the specification of “watts-per-channel” that you would you like the receiver to have. The end-user may specify a target value of “50 watts-per-channel,” or any other preferred target value. Alternatively, the Expert-Program modules might ask the end-user “How large is your room?” and based on the response to this question, the Expert-Program modules will set an appropriate target value to the Criteria, “watts-per-channel.” In addition, the information entered by the end user may further include a weighted importance value for each Criteria, identifying the level of importance the end-user places on each Criteria in identifying a best solution.

Once the end-user inputs information requested by the Expert-Program module, or accepts default information generated by the Expert-Program module which are based on rules and relationships programmed into the Expert-Program module, the Expert-Program modules passes control to the Solution-Engine. The Solution-Engine then uses complex algorithms to generate the Criteria target values and weighted importance values inputted into the Expert-Program module, as well as additional input information that will be detailed further below. The Solution-Engine correlates that information programmed into the Expert-Program module against the Criteria information associated with at least the Assets contained in the Database, which includes the specific Criteria and values that define each individual Asset. In addition, the Solution-Engine applies further complex processing steps to both the information programmed into the Expert-Program module and the Asset information, as will also be discussed in further detail below. The tangible output/result of running an Expert-Program module is the generation of a set of one or more optimized, or “best possible,” solutions to the problem. The set of optimized solutions at least includes the identification of one or more Assets from the Database that may represent the best solution to the problem. The optimized solutions may thus at least be based on information specified by the end-user, any default information accepted by the end-user, and additional problem-specific information programmed into the Expert-Program modules, all of which represents the end-user's specific needs, as well as the particular Assets available at that point in time.

For example, if the identified problem is one in which the end-user is trying to determine which product should be purchased among multiple options of a product type, a Solution can contain the identification of the best choice of the specific product (i.e. the Asset) that the end-user should purchase from those represented in the Database. In identifying the specific Asset that forms part of the Solution, the system has determined that the identified Asset, as well as its associated Criteria and specific Criteria values (i.e. characteristics) that define the Asset, are one of the best possible matches to best satisfy this end-user's needs. This determination is made based on all of the Criteria target values and weighted importance values either specified by the end-user or set as defaults, as well as the relationship rules programmed into the Expert-Program modules. In addition to the identification of one or more specific Assets, the Solution may also include the identification of the best available price at which the Asset may be purchased, as well as a list of, according to the end-user's specific needs, the best-possible retailers from which the Asset is available at that best price. However, as will be explained in further detail, the Solution can include additional or less information, depending on the specific problem to be solved and the type of Assets involved in the Solution. Indeed, any of the Criteria associated with Asset(s) identified in the Solution, the suppliers of those Assets, or any additional Criteria that may be of interest to an end-user may be included as part of the outputted Solution.

In another embodiment, an example might be a “Farm Expert” for helping an end-user manage a farm. Furthering the example, Assets representing various flora and/or fauna have been entered into the Database with associated Criteria, and the Expert-Program module has been suitably configured by the Author to model an operating farm via mechanisms including the hierarchical relationship model. For example, the model might represent aspects such as:

A unit of carrots requires water; amount W on schedule X.
Pigs require food; amount Y on schedule Z.
Carrots are 25% waste
Pigs can eat carrot waste
After 6 months, average pig weight is 150 Lbs
After 1 year, average pig weight is 225 Lbs
60% of a pig is pork

The Author likely models additional aspects not represented in this example, including (but not limited to) additional flora, fauna, and the resource requirements and interrelationships thereof.

Continuing the example, this Expert-Program module may be located and run by an end-user as detailed elsewhere. The end-user may be prompted to enter such criteria information as the cost of pig food, the sale price of pork and carrots, and initial capital available to be allocated among the purchase of pigs, carrots, and feed. It is understood that these are representative examples, and that additional aspects may be modeled and referenced without limitation. The end-user may then be prompted to enter information relating to both the “optimization target,” or resource the Solution-engine should seek to maximize, and “time frame,” or period of time over which optimization is to be sought. Continuing the example, the end-user may specify “profit” as an optimization profit, and “2 years” as a time frame.

As in the previous example, once the end-user inputs the Criteria information requested by the Expert-Program module, or accepts default information generated by the Expert-Program module, the Expert-Program modules passes control to the Solution-Engine. The Solution-Engine then uses complex algorithms to analyze the Criteria inputted into the Expert-Program module, as well as additional input information that will be detailed further below. The Solution-Engine correlates that information programmed into the Expert-Program module against the Criteria information associated with at least the Assets contained in the Database, which includes the specific Criteria and values that define each individual Asset. In addition, the Solution-Engine applies further complex processing steps to both the information programmed into the Expert-Program module and the Asset information, as will also be discussed in further detail below. The tangible output/result of running an Expert-Program module is the generation of a set of one or more optimized, or “best possible,” solutions to the problem, represented, in this example, by an expression such as (here oversimplified) “The purchase of $50 worth of carrot seeds, $300 in tilling equipment, $500 in pigs, and $150 in pig food will, after 2 years, result in optimal profit,” thereby reflecting not just identification, but allocation of Assets such as carrot seeds, pigs, and tilling equipment.

Problem Types

The system and supporting platform is flexible and powerful. It is able to represent many types of questions, challenges, problems, or other types of queries (collectively “problems”), and can provide optimized solutions thereto. In the broadest terms, the system described herein can be used to model and solve problems that involve either an end-user needing to identify (and subsequently, likely purchase) an option comprised of one-or-more items (i.e. Assets) from a set of multiple available options, as exemplified by a typical consumer purchase decision, or a problem to be solved involves the allocation of resources, represented by Assets which may-or-may-not need to be purchased, exemplified by a business model seeking to maximize profit through efficient resource allocation over time. This represents a significant percentage of all real-world consumer and commercial problems.

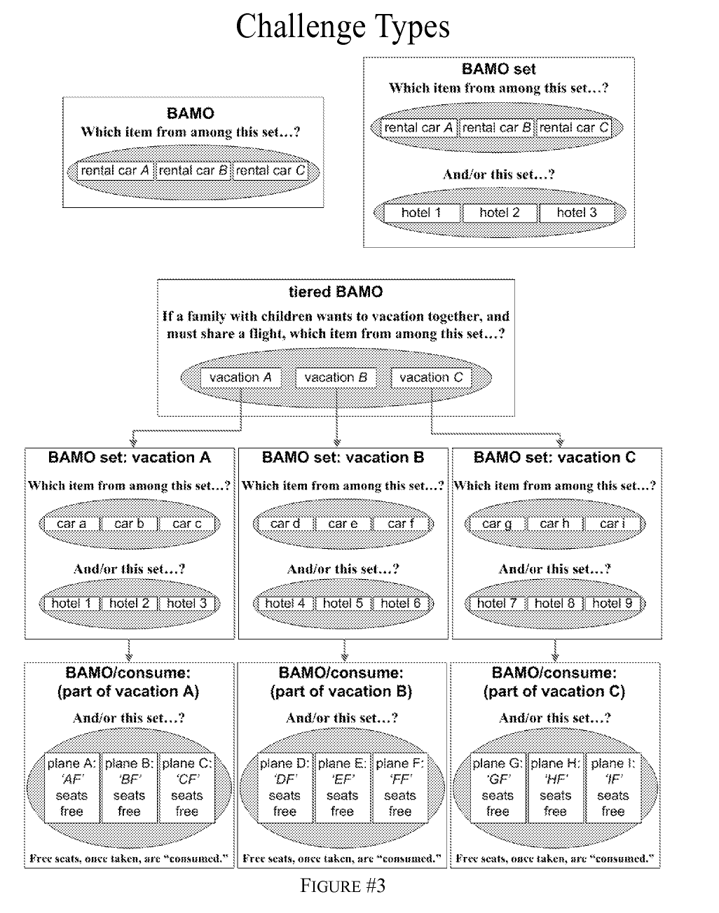

Referring to FIG. 3, problems such as this can be represented with four basic approaches, which may be combined: (1) the selection of the best item, or best allocation of best item, among many options (“BAMO”) (e.g. For a specific end-user and set of specific conditions, which is the single best item selection or allocation of good, service, or data/information among many possible items of the same/similar type?); (2) selection of the best set among many options (“BAMO set”) (e.g. For a specific end-user and conditions, what is the best set of items, or best allocation among these items, among many possible sets?); (3) the BAMO or BAMO set selection when one-or-more items, or items within a set, represents a subordinate set of items, such that a single Solution reflects two-or-more BAMO set Solutions, each reflecting a subordinate level (called “tiered,” or “tiered BAMO”) (e.g. For a specific end-user and conditions, what is the best set of sets among many possible sets of sets, each of which may represent other, subordinate sets?); and (4) BAMO set when item resources are constrained such that a limited quantity or amount is available for allocation and, once committed to a Solution (of any structure or type), becomes unavailable to other parts of the Solution, or other Solutions (called “consuming”). Finally, these approaches applied over time, thereby modeling dynamic systems.

While the system lends itself particularly useful to solving problems related to the selection of goods and/or services, it is not limited to this one type of selection problem. Rather, the system is capable of solving a broad range of selection problems including, for example, providing the end-user optimized solutions to: “how” an end-user should accomplish a task; “which”/“what” should be selected; “when” should an action be taken; etc. More specific examples include problems such as: “Where should the end-user wash his car?” “Which potential employment candidate is the best for a particular job opening?” “What locally-available wine, costing less than $20, should be paired with a given meal?” “Which available bike path in this geographic area should I take?” “Which of the three-bedroom houses that I am considering purchasing is in a great school district and also within walking distance of a train station?”

The problems that are capable of being solved by the system and the supporting platform are limited only by the availability of an appropriate Expert-Program module, the specific expertise incorporated therein as represented by the rules and relationships defined by the information and data elements therein, and the Expert-Program module's ability to address the given topic/subject-matter of the defined problem. If an Expert-Program module is capable of being programmed to incorporate some detailed level of expertise for a specific subject-matter, then the system and supporting platform can solve problems relating thereto.

Platform

In one embodiment of the present disclosure, the platform on which the system operates is HTTP/web-browser-based, in which the end-user accesses the system via the Internet through any number of standard web browsers (e.g. Internet Explorer, Firefox, Safari, etc.) loaded on a PC, or other similar hardware. The Expert-Program modules, Solution-Engine, and Database are thus typically located elsewhere on a remote server, or other similar hardware. Similar to standard Internet browsing, the end-user enters the Internet URL web address of the system's home web page into a web browser to access the system. However, the aspects of the present disclosure should not be read to limit the platform to being only a web-based platform. Accordingly, it should be understood that in alternate embodiments, the system is capable of running on any computing or processor based platform that provides (1) an interface by which end-users can enter and receive information and (2) processing and data storage resources (e.g. web-based, PC or laptop, tablet, smart phone, etc.).

In an alternate embodiment, the platform may be a complete stand alone PC system, or other similar computing platform. In this embodiment, the individual Expert-Program modules themselves, the Solution-Engine, and the Database may be stored locally on a PC. Software and Database updates may be uploaded (or downloaded) to the PC in any suitable manner, including for example, an Internet connection or locally connected storage drives. In yet another embodiment, the platform may be a locally stored executable program incorporating the Solution-Engine, which utilizes the Internet to remotely access the available Expert-Program modules, as well as the remotely stored Database. When the end-user finds the Expert-Program module(s) he needs, the local program calls up or downloads the remotely located Expert-Program module(s). The end-user then inputs the required information, and the Solution-Engine locally runs the Expert-Program modules to arrive at the optimized solution. In yet additional alternate embodiments, the system is capable of operating in any configuration with any of the system components located locally or remotely, or completely separate from each other.

Expert-Program Modules and Authors

As disclosed herein, the system further includes one or more Expert-Program modules, each of which is comprised of one-or-more “blocks,” as further detailed below. An Expert-Program module is a program written by an “Author,” which specifies, among other things, a set of rules and relationships that represent and encompass the Author's expertise in a given subject area or on a given topic. An Author can be any individual who has any level of expertise in a given subject-area, regardless of how broad/high-level or detailed and granular. For example, an Author “A” may possess a basic knowledge of the many ways of connecting home theater components, but at the same time not have any particular level of expertise related to the detailed operation of, and options available for, various individual stereo components. However, Author “B” may possess a high degree of expertise as to the detailed options available for stereo receivers, but not have any real expertise relating to other home theater components. Each Author may create an Expert-Program module or Block encompassing his own expertise, regardless of the level of knowledge or detail. In this regard, an Author can be someone of almost any age having topic or subject-matter expertise at almost any level.

In one embodiment, the Expert-Program modules are written in a relatively simple but powerful high-level scripting language and environment called General Purpose Schema Language (“GSL”). Organized around procedures, GSL encourages highly structured programming. It is a text-based programming language that expresses the Expert-Program module's logic (algorithms), manages end-user input/output (soliciting information and displaying helpful information), is relatively easy to learn, and is relatively intuitive. GSL is designed to help Authors express the problem to be solved without having to learn unnecessary syntax and abstractions.

With GSL, Authors can provide significant functionality and value to end-users with a few lines of simple code, accomplishing what would require hundreds or thousands of lines of code using a traditional, lower-level or general purpose language. Using GSL, the Expert-Program module model differs fundamentally from traditional rules-based programming models. Traditional models and programs use pre-programmed domain-focused rules or guidelines, which relate to the specific circumstances at hand and involve the specification of particular pre-programmed steps in an “imperative” fashion. Instead of rules, the system model of the present disclosure uses simple language and expressions to model relationships based on characteristics in a “declarative” fashion, and the platform effectively figures out for itself which specific rules to apply under the given set of conditions. In the system disclosed herein Authors (the human experts) express their knowledge, not exclusively with rules, but by using GSL language and mechanisms such as abstract expressions in order to model relationships between Assets based on the associated characteristics (i.e. Criteria) of those Assets. These relationships can subsequently be modeled and expressed cooperatively and hierarchically. A traditional expert system knowledge base may have many rules; thousands or tens-of-thousands. The system of the present disclosure supports expression of complex systems using relatively more simple language and more highly-abstracted terms. This results in relatively smaller, less-complicated, yet more efficient and more powerful Expert-Program modules.

GSL represents a “fifth-generation” language, in that, in many instances, for the classes of problems the system solves, the Author need only express the constraints or conditions of the problem using a relationship model, as disclosed throughout this specification. The exact algorithm required to solve the specific problem is not specified by the Author, but is effectively created by the system, dynamically, in accordance with the relationship rules expressed by the Author through his Expert-Program modules.

The Asset-Criteria, referenced briefly above and detailed below, represent characteristics inherent to specific Assets. While these are essential to Asset selection and evaluation in the formulation of a Solution, Authors are encouraged, via the abstraction model supported by GSL, to create Expert-Program modules which appear to end-users fully-and-completely focused on end-user needs rather than exposing end-users to Asset-Criteria, and related or similar details. In one embodiment, GSL therefore functions as an end-user requirement to Solution translation system which, via Experts representing Authors' expertise, helps end-users discern their needs, and translates these likely abstracted needs to specific Asset-Criteria parameters for selection and evaluation. Thus, in one embodiment, prior to the delivery of a Solution, there may be little-or-no direct exposure to end-users of Asset-Criteria, and related or similar details.

In another embodiment, as detailed below, end-users may, as directed by their interest, Author's control via GSL, and related platform features, engage fully and directly with Asset-Criteria, directly adjusting, for example, target values and importance weighting to direct or refine a Solution. Thus, the degree of direct engagement between end-users and Asset-Criteria may range from none to complete.

Because of GSL's relative simplicity, in order to learn to write GSL code and thus create Expert-Program modules, Authors need only to be able to think logically and follow relatively simple rules of syntax and expression. In addition, to write an Expert-Program module the Author will need to first have knowledge of, and some level of expertise in, the specific topic or subject-area for which the Expert-Program module will be written.

In another embodiment, the text format of GSL which may define an Expert-program may be generated by a preliminary process of even higher-level abstraction. In one embodiment, aspects such as (but not limited to) Criteria, abstractions such as “better,” logical operations, vectors indicating direction and/or magnitude, and expression mechanisms such as connectivity, hierarchy, and compatibility may be represented by abstractions such as icons and/or graphics, and such graphics may be graphically selected, categorically organized and/or manipulated by the Author. Thus, an Author may create an Expert-program expressing domain expertise without creating, or indeed seeing a GSL text file. In another embodiment, an interactive expression builder may provide structured assistance to an Author. In another embodiment, the platform may engage Authors in a directed dialogue, soliciting information which can subsequently be used to create an Expert-program. Thus, mechanisms such as text file creation and manipulation of representation graphics are exemplary mechanisms of Expert-program creation, and do not represent limit or restriction on the mechanisms through which Expert-programs may be created, or the hierarchical relationship model detailed herein may be expressed.

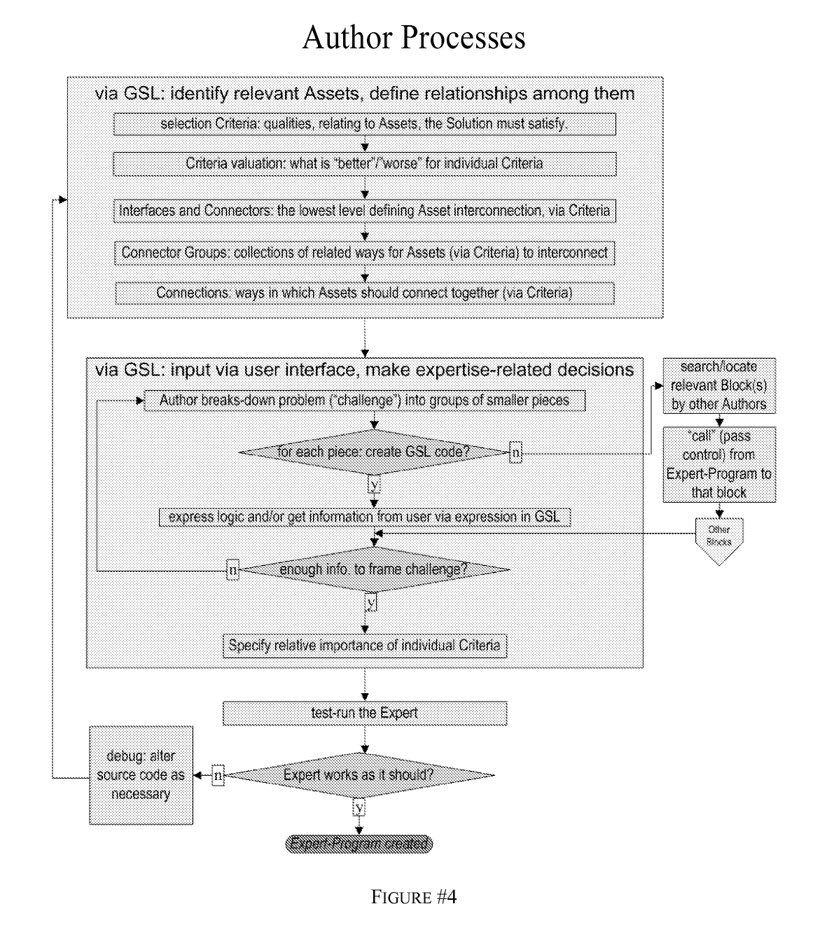

Referring to FIG. 4, one example of a process for an Author to write or develop an Expert Program is illustrated. In one embodiment, when an Author prepares an Expert-Program module on a given subject area in which he has some level of knowledge (e.g. home theater systems, etc.), the Author is framing the anticipated and projected end-user needs that he believes should be important, by a) soliciting end-user input on points for which the Author lacks complete end-user-specific information, b) selecting specific Criteria, as well as the associated target and importance values for those Criteria, c) specifying the relationship among Assets, the end-user, and, optionally, other parties by describing the specific dynamics of interaction, including rules of association and connectivity, among Assets and these parties. More specifically, in one embodiment the Author identifies and refines end-user needs by identifying all of the specific Criteria that may be relevant to an end-user in the determination of a Solution. This stage is generally referred to as the identification of end-user “Selection-Criteria.” In laying out the specific Selection-Criteria, the Author is specifying Criteria representing qualities the Author considers necessary to solve the problem addressed by the Expert-Program module. These Criteria are then used by the system to select appropriate Assets which potentially meet/satisfy these Criteria. In addition, each of the Selection-Criteria the Author identifies and programs into the Expert-Program module is a Criteria for which an end-user may have the ability to input a target data and importance value when running the Expert-Program module.

In one embodiment, Criteria have both a data and importance component. The data component is the target value(s) that should be sought by the Expert-Program module for that particular Criteria. The importance component is the weighted importance value of that Criteria, and its associated target value(s), in relation to the other Criteria that are being considered in the determination of a Solution to the end-user's problem. Any Criteria, including Selection-Criteria, may have a set of “Defaults” determined, or specified, for the Criteria's target value or weighted importance value. Defaults are the default target values and importance values which, once defined, are accepted by the system unless altered, with such alteration typically resulting from the actions or inputs of the end-user. Thus, when applied to Criteria, Defaults involve the expression of one or more default target values and, optionally, one or more default importance values. Defaults, as set by the Expert-Program module according to the terms specified and programmed by the Author, represent specific target and importance values for the Expert-Program module to use as suggested starting points in the determination of what Criteria an end-user wants in a Solution, the target value that the Criteria should optimally have, and how important that Criteria and its target value are in the determination of an overall Solution to the problem. The Defaults are set based on the Author's expertise, which reflects both the Author's subject-area mastery and his insight as to what the end-user might, or should, need, depending on the end-user's needs under various conditions and circumstances. This is especially helpful for end-users who have little knowledge of a subject-area in which the Author is an authority. For end-users, the Expert-Program module thus functions in a manner similar to a knowledgeable salesperson.

Thus, in one embodiment, in addition to the Author identifying and defining each Selection-Criteria that the Author believes an end-user would, or should, want considered, the Author also applies Defaults to one or more Criteria as discussed above. Such Criteria may include not only the Selection-Criteria previously specified by the Author, but also any additional Criteria that may be newly introduced by the Author for consideration. When determining appropriate target and importance value Defaults for Criteria, the Author may determine what is in the end-user's best interests under one or more conditions and circumstances.

For example, the Author may specify a recommended target value direction (e.g. high, low, greater, etc.), a target value range, and/or a singular specific target value (e.g. a specific target number, the presence or absence of a function or ability, etc.) as the default target value for a particular Criteria within the Expert-Program module. In further more specific examples, some Criteria, like TV screen resolution, are generally better for the end-user when their target value, or target direction, is “greater.” Other Criteria, like cost, are generally better when their target value, or target direction, is “lesser.” And some Criteria, like the “fit” of something or “schedule-related” events, are generally best when their target value is closest to the center of a range. Similarly, applying default importance values allows the Author to use his expertise to specify a starting point for how important he believes a particular Criteria, and its associated Criteria target value, should be to an end-user in the determination of a Solution. Depending on the particular circumstances, some Criteria are inevitably more important than others to the task of arriving at the best solution to a problem, and they should accordingly be given a higher weighted importance value.

In one embodiment, the Author may specify that under certain conditions one or more Criteria Defaults will be specific static values chosen by the Author, wherein the specified static values do not change regardless of other conditions that may be present. In another embodiment, the Author may define a set of rules to enable the Expert-Program module to determine appropriate default values for one or more of the Criteria. The set of rules may reflect dynamic situations and conditions, and the Expert-Program module may indicate that, under different conditions, different rules should be created and/or applied. For example, under circumstance or condition “A,” apply rule “X;” under circumstance or condition “B,” apply rule “Y.” As a result of such rules, differing outcomes may result from different circumstances and conditions, and Default target values for Criteria may thus be set according to the Author's perspectives on dynamic conditions and end-user needs.

In one embodiment, for example, the Expert-Program module's rules tell the Expert-Program module to seek a particular default target-direction for a given Criteria under one set of conditions and another default target direction under a different set of conditions. The target-direction here represents a more generic “goal” or “target” (e.g. “high,” “low,” “bigger,” “smaller,” etc.) that the Expert-Program module should ideally look for in an Asset Criteria (or other applicable Criteria). The Expert-Program module then selects the appropriate default target-direction to seek-out, based on which of the one-or-more Author specified conditions have been satisfied. In such an example, a rule might express the default target-direction for a Criteria associated with the “price” of something as: “if ‘buying,’ seek ‘a low price’; if ‘selling,’ seek ‘a high price’.” Here, ‘low price’ and ‘high price’ are the target-directions, and ‘buying’ and ‘selling’ are the conditions the Expert-Program module uses to determine which target-direction should be used as the default target-direction. In such an example, “buying,” “selling,” “low” and “high” would be defined elsewhere, and might themselves be defined conditionally. Rules which determine appropriate Defaults for Criteria may be selected and/or affected by conditions defined by any number of factors, such as those relating to Assets, end-user preferences, etc. Thus, in one embodiment, both rules and static values can be used by the Expert-Program modules, in any combination, to set Defaults for Criteria.

While embodiments discussed thus far provide for the Author setting the default Criteria target values and weighted importance values, in alternate embodiments, (a) Defaults for all Criteria may be overridden by the end-user at any time, (b) Defaults for some Criteria, but not others, may be overridden by the end-user, or alternatively (c) none of the Defaults for any Criteria may be overridden by the end-user. The determination of which Defaults may be overridden is made by the programming Author writing the Expert-Program modules, and general constraints as applied (or relaxed) by the platform which may selectively affect Expert-Program modules. If the Author allows the end-user to override one or more Defaults when running an Expert-Program module, the end-user will see the Default values for each identified Criteria. The end-user may cycle through each Criteria whose Defaults can be modified and chose to keep the Author's pre-selected Default values, or edit those values to suit his specific needs. In this manner, the Defaults are dynamic Defaults capable of being changed by the end-user.

In the previous embodiments, Default Criteria target values and weighted importance values may be input for several reasons. First, as previously stated, specifying defaults provides the end-user with the Author's insight and expertise as to what the Author believes is better for the end-user based on the end-user's needs under various conditions. It provides the end-user with the Author's insight on the many, often nuanced Criteria that may need to be considered to arrive at an optimal solution to a problem. Second, in an embodiment of the system, the Solution-Engine may not allow the system to generate a Solution without first having at least a target value, and possibly an importance value, assigned to each identified Criteria, thereby ensuring all identified Criteria are considered in the determination of the best solution. Thus, if the end-user fails to input his own target value for a specific Criteria prior to turning over control to the Solution-Engine, the system will use the Default target value set by the Author.

While previous embodiments provide for the Author setting Default Criteria target values and weighted importance values, in another embodiment, there may be no Default values established, thereby requiring the end-user to specify a target value and importance value for every identified Criteria, in order for the system to run properly. In yet another embodiment in which no Default values are specified, if an end-user does not input a target value or weighted importance value for a particular Criteria, then that Criteria will not be considered when the Expert-Program module is run through the Solution-Engine.

Hierarchical Relationship Model

If the Author writes an Expert-Program module to address a “BAMO” type of selection problem (i.e. the selection of the best single Asset among many available options), he may need only to identify and program into the Expert-Program module those Criteria and parameters that are relevant to that particular selection problem, in order to achieve great solutions upon the Expert-Program's execution. However, in many instances, individual Assets (e.g. almost all electronics, cabling, etc.) are capable of, and designed for, connection to other Assets; either actual, real-world, physical connections, or more abstract ideas of connections, such as how two things interrelate. This includes the usual “plug ‘A’ to socket ‘A’” connection scenario, but also other forms of interconnection, such as scheduling and “time-and-place” common in travel (a traveler having to “make a connection” between “transport ‘A’” and “transport ‘B’”). Solutions frequently involve some form of interconnection among Assets within the set. If a Solution involves only one Asset, Connection considerations may still apply among that Asset, and items the end-user may already own. Often this leads to a “tiered” type of problem. Accordingly, to take such connection possibilities into account as part of the Solution, the Author may define relationships among various objects and parties (e.g. Assets, End-users, Providers, etc.) via their respective Criteria. Authors express object relationships using a connectivity-base hierarchy.

As noted above, Criteria-based relationship definition is optional, not a requirement for generating a Solution. Selective or incomplete relationship representation within an Expert-Program module does not compromise a Solution beyond the inability of the Solution to reflect the potential benefits of fully-realized Criteria-related relationship considerations.

Interfaces

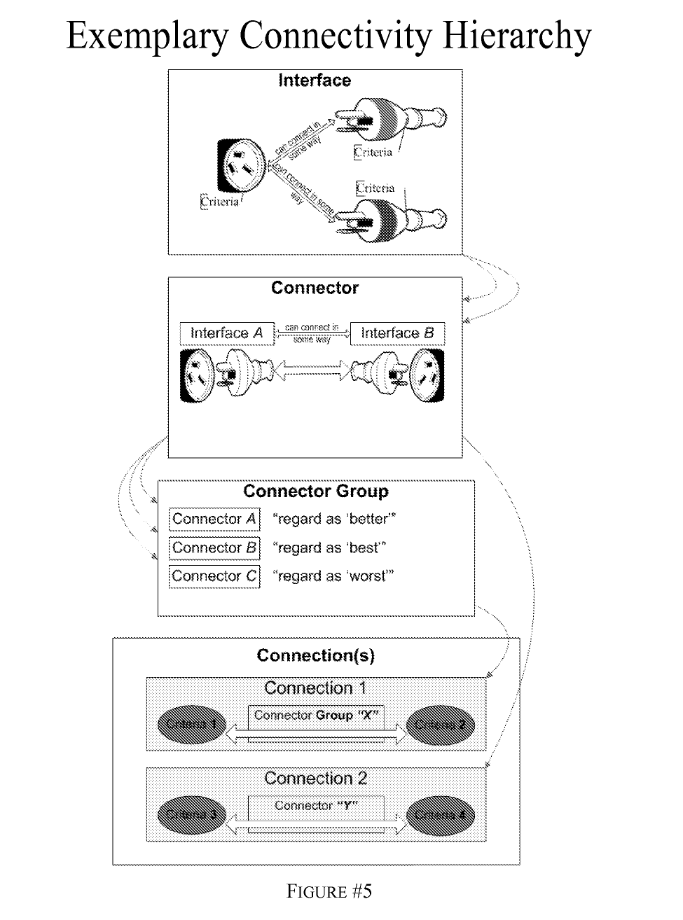

Referring to FIG. 5, at the base level, Interfaces are a hierarchical level above Criteria and define what Criteria can connect or related to what other Criteria on the lowest hierarchical level of connectivity. Two or more Criteria that can connect together define an Interface. Interfaces essentially represent the ability for existing Criteria from two or more separate Assets to interconnect; “Criteria ‘X’ to Criteria ‘Y’.” In one embodiment of the GSL language, an Interface can be expressed using the exemplary format:

“New Interface Name” as “Criteria ‘X’” to “Criteria ‘Y’”

where “New Interface Name” is the name of the newly-defined Interface, and “Criteria ‘X’” and “Criteria ‘Y’” are the names of existing Criteria associated with one or more Assets. For example, referring to FIG. 5, for a compatible plug and wall socket, the Interface may be defined by:

Define Interface “A.C. wall connection” as “A.C. plug” to “A.C. wall socket”

This line of code defines an Interface named “A.C. wall connection,” as the way the plug of a power cord from a device can be plugged into the socket of an A.C. wall outlet. Similarly, another Interface may be defined by:

Define Interface “A.C. device connection” as “A.C. plug” to “A.C. device socket”

This line of code defines an Interface named “A.C. device connection” as the way the plug at the other end of a power cord connects to the appliance.

Thus, during this step, the Author actually programs and defines all the relevant ways in which relevant Criteria from multiple Assets can be interconnected to each other. Each of these Author-defined Interfaces represents the “ability” of a Criteria to connect to another Criteria, but does not require that they be interconnected in any particular manner. Each Asset may have multiple ways for connecting to another Asset (e.g. a TV has many different interface options for connecting to a DVD player, including HDMI plug to HDMI socket, S-video plug to S-video socket, component video plug to component video socket) and therefore, defining multiple Interfaces may be necessary. The Interface details the ends of the interconnections between Assets, but not the middle portion between two the two Interfaces. Accordingly, the Author may next specify various “Connectors;” the middle portion between two Interfaces.”

Connectors and Connector Groups

A Connector is a hierarchical level above an Interface and defines the way in which two or more Interfaces can be connected together, or interconnected. In the GSL language, an Interface can be expressed using the format:

“New Connector Name” as “interface ‘X’” to “interface ‘Y’”

where “New Connector Name” is the name of the newly-defined Connector and “Interface ‘X’” and “Interface ‘Y’” are previously defined Interfaces. For example, referring again to FIG. 5 as an exemplary visual aid for the concepts contained herein, and continuing with the example from above, a Connector called “A.C. power cord” may be defined by:

Define Connector “A.C. Power Cord” as “A.C. wall connection” to “A.C. device connection.”

This line of code defines a Connector named “A.C. Power Cord” as the connection between the two previously defined Interfaces. Thus, during this step, the Author actually programs and defines all the relevant ways in which previously defined Interfaces can be interconnected to each other. Each of these Author defined Connectors represents the “ability” of a previously defined Interface to connect to another Interface. As was similarly the case with the programming of Interfaces, if multiple Connectors can be defined for two or more Interfaces, programming in these multiple Connectors only specifies that one of the multiple Connectors can be used for the Connector between any two Interfaces, but it does not specify which particular one should be used.

While previous and future examples and embodiments may specify a particular format in the GSL language for the programming or defining of an Interface, Connector, Connector Group, or Connection, or any other programming aspect of an Expert-Program module, such formats should not be read to limit the specific format that may be used to program and define such aspects of Expert-Program modules. As such, these formats used in examples and embodiments are only exemplifications as to how such aspects may be defined. In alternate embodiments, additional programming formats and terms may be used to program such aspects of Expert-Program modules without departing from the scope, concept, and intent of the disclosure contained herein.

The Author has now potentially defined multiple individual Connectors, which detail valid “beginnings,” “middles,” and “ends” of how Criteria from two or more Assets may be interconnected, and thereby, the Assets themselves. However, there may be multiple available Connector options for interconnecting the specific Criteria, while only one interconnection is needed. Furthermore, the Author may have specific preferences as to which of the interconnection options will better satisfy the end-user's needs than others.

As is shown in FIG. 5, and as an exemplary visual aid for the concepts contained herein, the Author next defines various “Connector Groups,” which are two-or-more previously-defined Connectors sharing common characteristics that are represented together in a group. The individual Connectors included in the Connector Group continue to exist as independent logical entities (i.e. they continue to be available in the same way as other Connectors not in Groups), but may also now be referenced through their Connector Group affiliation. In each Connector Group, the Author lists all of the possible previously defined Connectors that can be used to interconnect two or more specific Criteria. The Author also specifies, for each available Connector option within a Group, the preference for the use of that Connector as compared to the other Connector options within the Group. This is done by assigning each Connector option within the Group with a weighted preference or desirability value. The weighted value indicates which Connector should be the preferred Connector(s) to use to interconnect two or more Criteria. For example, to receive video signals from a Blue-Ray Player, a video display device can use composite, component, S-Video, DVI, or HDMI-based Connectors. But composite is rarely recommended, component is slightly more-preferable, and DVI or HDMI are greatly preferred. Any of these options will work, but the Author needs to indicate the specific options, and their relative preference or desirability in comparison to each other.

For Example, in the GSL language, one embodiment of a Connector Group can be expressed using the format:

```
begin group
  name = “the Author-assigned name of the connector group”
  behavior = “the Author-assigned behavior type of this connector group”
  “behavior” qty = “the number relevant to the behavior type assigned
  in the line above”
  begin connectors
    “name of connector 1” = “Primacy” (i.e. weighted preference)
    “name of connector 2” = “Primacy” (i.e. weighted preference)
    “name of connector 3” = “Primacy” (i.e. weighted preference)
    ...continue to list additional Connectors
  end connectors
end group
```

In this exemplary format, the assignment of a “name” specifies the label by which the particular Connector Group can be referenced elsewhere in the Expert-Program module. “Behavior” specifies the basic type of behavior associated with the Connector Group. “Behavior qty” indicates that, according to the terms of the Behavior type associated with this group, some number of Connectors specified within this Connector Group is required to satisfy the specified behavior. The “name of connector #” is the specification of one or more previously defined Connectors that are to be included within the particular Connector Group. The specified Connectors within the Group may also be assigned a “Primacy” value, which is the relative degree of preference-of-use, as between the other Connectors within the Connector Group, reflecting the Author's perspective on preference of all end-users, or the particular end-user executing the Expert-Program module.

For the exemplary programming format above, one example of a Connector Group “behavior” is “consume,” which indicates that the Connectors specified in the Connector Group, if used to satisfy a logical condition, are then “consumed,” and subsequently not available to satisfy other logical conditions within the Expert-Program module, which might also require such a Connector, such other conditions thus requiring an additional such Connector. Continuing with the “consume” example, the “‘behavior’ qty” label is rewritten as “consume qty.” Continuing further, “consume qty=1” would indicate that only one Connector within the Connector Group is required by the Expert Program, whereas “consume qty=all” would indicate that all of the specified Connectors are required. Another example of a Connector Group “behavior” type is “share,” which indicates that the Connectors specified in the Connector Group, if used to satisfy a logical condition, are subsequently available to satisfy other logical conditions within the Expert-Program module, which might also require such a Connector (i.e. they are “shared”). “Share qty” then indicates the number of Connectors required, and also available for sharing. However, in alternate embodiments, alternate Connector Group “behaviors” may exist that specify that alternate, or conditional, logic be applied to the process of Connector evaluation and selection in the context of an Expert-Program module and Solution.

Additionally, the “behavior” of Connector Groups may be altered in accordance with the effects of other system platform features, such as “Affinity/Aversion.” Affinity is the specification of “selective attractive force” among objects, while aversion is the specification of “selective repulsive force” among objects such that, in one embodiment, for example, the following expression might occur within the definition of a Connector Group:

affinity with “group ABC” = 5
aversion from “group “DEF” = 7

Such an expression indicates to the Solution-Engine that, when evaluating potential Solutions, there should be preference to pair the particular Connector Group in which this expression is programmed with Connector Group “ABC,” and to avoid pairing this Connector Group with Connector Group “DEF.” Furthermore, in one embodiment, the Primacy can be applied by assigning each Connector with a numerical value, from 1 to 10 for example, or on some other scale (e.g. low-medium-high, etc.) to indicate which Connectors are more, or less, preferred, as compared to the other Connectors in the Group.

As a more concrete example, the following GSL programmed Connector Group identifies a group of transportation modes specified by an Author, for use in solving a problem related to an individual getting from point A to point B. The below Example also defines the appropriate corresponding behavior of the Group.

```
begin group
  name = plane, train, or automobile
  behavior = consume
  consume qty = 1
  begin connectors
    plane = 9
    automobile = 7
    train = 5
  end connectors
end group
```

In this example, the Author defines a Connector Group called “plane, train, or automobile,” and specifies that one or more Connectors are required to be used by stating that the “behavior” is “consume.” The “consume qty=1” indicates that one, and only one, of the Connectors included in the Group are needed. The Author further lists the pre-defined Connectors that are included in the Connector Group, as well as their Primacy values on a scale from 1 to 10; the “plane” Connector is, according to the Author, the most preferred Connector for the end-user running the Expert-Program module, with a Primacy value of 9, then the “automobile” Connector with a Primacy value of 7, and lastly the “train” Connector is the least preferred with a Primacy value of 5.

Connections

Again referring to FIG. 5, the Author may also define “Connections,” which are a hierarchical level above Connectors and Connector Groups. Connections define the way in which Assets, through their associated Criteria, should connect together. The Author writes the Expert-Program module to instruct the system that, under certain defined conditions the system needs to try to connect these two, or more, Criteria. The Author can specify that the system should connect Criteria either (i) through a specific pre-defined Connector if, for example, there is only one way to connect two Criteria or a specific way the Author wants two Criteria connected, or (ii) through a Connector Group if there are multiple ways to connect two or more Criteria. For Example, in the GSL language, one embodiment of a Connection can be expressed using the following exemplary format:

```
begin connection
  connection name = “Name of Connection”
  connect = “Criteria ‘X’” to “Criteria ‘Y’”
  through connector group = “specify a pre-defined Connector Group”
  ‘ [or, if not through a Connector Group, “through connector = ‘specify a
pre-defined Connector’”]
  with affinity = “Author-specified affinity value”
end connection
```

In this example format, the Author first defines the name of the Connection. Next the Author defines which Criteria should be connected in this defined Connection. The Author also specifies whether the Criteria should be connected through the options and preferences expressed in a previously-defined Connector Group, or by a specific individual Connector. The Author may also specify an “Affinity” value for the particular Connection, which again is the degree of positive or attractive force with which the system should try to connect the two or more specified Criteria, as defined in the Connection. If the Author specifies a high enough Affinity value for the Connection, then the system must connect the two Criteria. However, if a Connection between two Criteria is less important, the Author specifies a lower Affinity value, which is the Author's way of telling the system that it would be nice if the system could find a way to connect the Criteria, however, it is less important or possibly not a requirement. Regardless of the Affinity that is specified in connecting two or more Criteria, if the Author is specifying a Connector Group, the Author is not specifying how the system should connect the Criteria. The decision as to how best to connect the identified Criteria is left for the system to determine, based on the Connector Groups and associated preferences defined therein, and potentially other aspects of the platform relationship model.

Time Model

Representation

In one embodiment, the Author may define and use variables to represent periods of time associated with either a real-world calendar and/or clock or an internal mechanism not directly representative of real-world time. A special case is represented by “model lifespan,” which defines the “model” time over which, if so specified by an Expert-Program module, formulation of the Solution is to be evaluated. In the context of evaluation, time periods are representative such that, for example, while the specified Model Lifespan may be a year, the actual (“real-time”) period of time required to complete the evaluation representing a calendar year may be only seconds. For example, in a representation of the GSL language (not exact regarding syntax), one embodiment of a Time can be expressed using the following exemplary format:

```
begin model time
  model lifespan = week
  “three times a day” = 8 hours
end model time
```

In this example format, the Author defines Model Lifespan as representing one calendar week, and the label “three times a day” to represent the passage of 8 hours.

In another embodiment, the parameter “importance” is associated with a time definition as a directive of “strictness to adherence.” This offers a simple mechanism for the “inversion” of time with other parameters. For example:

imp:“model lifespan”=5

In this example format, the Author indicates that Model Lifespan is less important, with an associated value of “5,” than the default of “invariable” (or a higher number). Consequently, a Solution will likely reflect, and possibly favor parameters to which a higher importance has been assigned. Extending our example, if a variable such as “profit” had been assigned much greater importance than Model Lifespan, the Expert-Program module effectively solves for “profit” rather than “time,” whereas assigning a much higher, or default expression of importance to Model Lifespan regards “time” as invariable, and solves for “profit” within the specified Model Lifespan.

Transform

In one embodiment, the Author may define a Transform as an encapsulation of one-or-more conditions which, when satisfied, conditionally affect one-or-more Assets, Asset Criteria, an expression of relationship hierarchy (e.g. Interfaces, Connectors, Connections), or other GSL-supported abstraction (e.g. Affinity/Aversion, Importance, or other Transforms). Such encapsulations can subsequently be referenced by their corresponding label. Effects generated by Transforms may include the alteration of a value or parameter, but also creation and/or deletion of abstract objects, such as those mentioned previously.

For example, in a representation of the GSL language (not exact regarding syntax), one embodiment of a Transform can be expressed using the following exemplary format:

```
begin transform
  name = “animals get hungry”
  frame = “three times a day”
  order = 2
  begin condition
    CRIT:”category” = LIT:”animal”
  end condition
  begin change
    criteria = “hunger”
    direction = increase
    amount = 12%
  end change
end transform
```

The above example may be summarized as: “If something is an animal, increase it's hunger three times a day.” In this example format, the Author assigns to the Transform the logical label “animals get hungry”. The “frame” parameter indicates that, when the Solution is being evaluated over the period of time represented by Model Lifespan, the transform is to be considered every “three times a day,” elsewhere defined as 8 “model” hours. The “order” parameter indicates that, in the event this Transform is scheduled to be considered at the same time as another, it will be considered subsequent to any lower-ordered Transforms. Upon each scheduled invocation, the terms indicated within the “begin/end condition” expression block are evaluated, and may include any combination of expressions and Boolean operators. If these conditions are logically true, terms specified within the “begin/end change” expression block are effected. In the exemplary format, the Transform is applicable to Assets with an associated Criteria called “category,” and with the associated value of that Criteria as “animal.” The exemplary format next specifies what is to happen if the condition is true, and according to the specified schedule, within the “begin/end transform” expression block. In the example, the Criteria “hunger” is increased 12%.

Once defined, Transforms may selectively enabled and disabled while Solution are being generated. For example, in a representation of the GSL language:

if EU:“pets are present” = true
activate transform “animals get hungry”
endif

In this example format, if the logical construct (the value of the variable “pets are present” is logical-true) evaluates logical-true, the Transform “animals get hungry” is activated by the Expert-program module.

Dynamic Evaluation

If Model Lifespan has been defined and is active within an Expert-program module, and one-or-more Transforms have been defined and are active, the Solution reflects a fully-dynamic evaluation process in which the model incorporating connectivity, hierarchy, relationship, and Transforms (and other features documented herein) is evaluated repeatedly, with each outcome representing the initial state for the subsequent one, for the duration of model time specified by Model Lifespan. For example, if within an Expert-Program module, Model Lifespan is defined as “one week” and a Transform is present with a frame defined as “one day,” the Expert-Program module will, unless otherwise directed, evaluate and, if appropriate, apply the Transform seven times consecutively, thereby generating a Solution which is optimal for a set of dynamic conditions, over time.

Examples and embodiments of model time and Transforms should not be read to limit the specific format or implementation of such features. In alternate embodiments, Transforms may include multiple frames, conditions, and changes. As previously noted, Transforms may also alter other abstract objects, including the creation and alteration of additional Transforms, or themselves.

Expert-Program Module Blocks

In one embodiment, the Author may program a complete Expert-Program module in the manner disclosed above, specifying Selection-Criteria, Interfaces, Connectors and Connector Groups, and Connections for every individual piece of the problem-to-be-solved. However, in alternate embodiments, the Author may program part of the Expert-Program module in the manner disclosed above to deal with one or more discreet pieces of the problem, but, as will be discussed further below, may also call on and incorporate into the Expert-Program module additional “blocks” of pre-programmed expertise. These Blocks that are called upon by the Expert-Program module contain the programmed expertise of either the Author's own work or that of another Author, so as to address additional discreet pieces of the problem-to-be-solved. In yet another embodiment, rather than writing all of the programming for Selection-Criteria, Interfaces, Connectors/Connector Groups, and Connections himself, an Author could write an Expert-Program module that only calls upon other Blocks that have already been written. With these various embodiments, the Author is at all times deciding how granular a perspective he wants regard the problem and the manner in which he is relying on his own expertise, or the expertise of others to address the overall problem, or certain aspects of that overall problem. Once the Author has completed the programming of the Expert-Program module, he test runs the Expert-Program module to make sure it runs properly. Once the Expert-Program module has been debugged, the Author releases the Expert-Program module to the platform so that is available to be used by end-users.

As discussed briefly above, in addition to programming completed Expert-Program modules in a more traditional manner, Authors are also able to program their expertise into one or more program blocks. Blocks, as that term is used herein, generally refer to discreet packages of GSL coded programming that represent at least some part of an Author's subject-matter expertise. They are smaller in scope than a complete Expert-Program module, but unlike a completed Expert-Program module, Blocks cannot be executed by an end-user. Blocks are written solely to be called-upon for use by Authors within executable Expert-Program modules, or by other Blocks. Each Block represents a specific problem-related concept, or piece of an Author's expertise, containing a package of logic and data for use within another Block or Expert-Program module. Both Blocks and Expert-Program modules have their own GSL code, attributes, and policies governing how they behave, as set by each of their respective Authors. However, some “master” attributes (e.g. the visual style of the Expert-Program module) are associated with, and driven “top-down” by, the Expert-Program module. Thus, Blocks will inherit some key attributes of the calling Expert-Program module. Expert-Program modules pass and receive both execution control and variable values to/from Blocks using the traditional “main/subroutine” programming model.

According to the Author's style and intent, a program Block may represent varying degrees of granularity and specificity within any given subject area of expertise. Thus, Blocks may be relatively higher-level, expressing a larger concept (e.g. “help design a home theater system”), or relatively lower-level, encapsulating a small, discrete, more granular level of detail and expertise (e.g. “help specify a stereo connection type”). The scope of a Block aligns with how people think about things, not technical guidelines. Blocks access specifically designated “resources” (e.g. pictures, text, audio, and video), which are then available to contribute to a rich, dynamic end-user interface.

In one embodiment, an individual Expert-Program module can be programmed to run based solely on the Author's own knowledge and expertise. However, Expert-Program modules may also be organized to incorporate a collection of separate Blocks. In this manner, Authors are also able to easily build Expert-Program modules by programming them to “call” and use one or more Blocks to bring in expertise piece-by-piece. These called Blocks may include Blocks the Author has written himself, as well as the Blocks of other Authors, whose Blocks may connect to yet additional Blocks by additional Authors, each of which represents additional expertise of varying detail in the same or additional subject areas. The exact manner in which Blocks rely on each other, and who may have written them, is of little concern to the Author, who knows simply that his Block, or complete Expert-Program module, calls other Blocks to perform required tasks. While ultimate control of Expert-Program module execution remains with the Expert-Program module, this potentially makes the execution process of an Expert-Program module highly decentralized. It is thus possible for a larger Expert-Program module to be written wherein the Expert-Program module is little more than a skeletal framework, which calls upon and organizes the expertise contained in additional, more detailed and granular, lower-level Blocks.

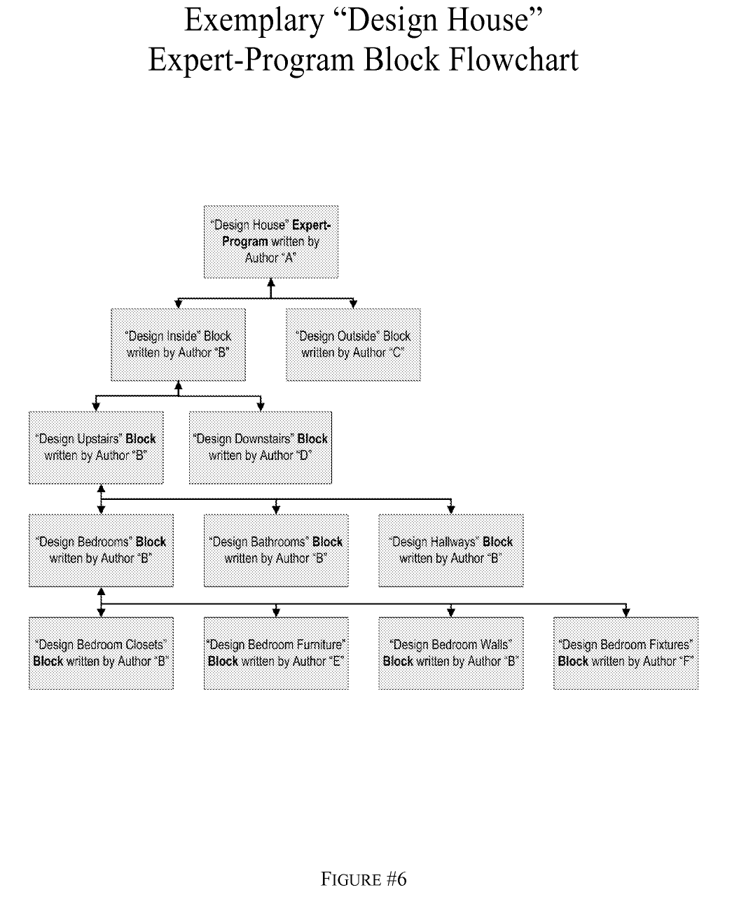

For example, referring to FIG. 6, an Expert-Program module to address the design of a house, called “Design-House,” may be configured by calling only two Blocks; the “Design-Inside” and “Design-Outside” Blocks. The “Design-Inside” Block may itself call the “Design-Upstairs” Block, which in turn calls Blocks for bedrooms, bathrooms, etc. Thus, an entire Expert-Program module can be programmed and configured by an Author simply by referring to and calling up one-or-more Blocks. In addition, the “Design-Inside” and “Design-Outside” Blocks and their respective Authors may not have any other association outside of their use within the “Design-House” Expert-Program module. In this manner, the system is essentially a “social solution system” reflecting “social intelligence” and, potentially, the collective, interdependent expertise of hundreds, thousands, or even millions of different Authors.

The exact operating mechanism of a given Block is the proprietary property of its Author, and thus the specific source code of the Block is hidden from everyone else, including other Authors who may call that Block. Calling Authors find individual Blocks they may wish to use by utilizing the system's platform interface and standard search features. Authors who call-up Blocks also choose the specific Blocks they want to use based on associated characteristics such as the Block's description, the type of input information needed for the Block to function properly, the type of output information returned from the Block for use within the Author's own Expert-Program module or Block, ratings of the Author who created the Blocks, ratings of the Blocks themselves, etc. All of this information can be provided to a searching Author as part of the search results when running searches for various Blocks. Authors can review the search results to see, among other things, (a) what input and variables a given Block needs to be provided with in order for it to function properly, (b) the required type/format of the variables to be sent to the Block as input, and (c) the order in which the Block requires the variables be provided. A searching Author can also see what the output variables that a Block will return to a calling Expert-Program module, or calling Block, as well as the type and order in which the returned output variables and information will be provided back to the calling Expert-Program module.

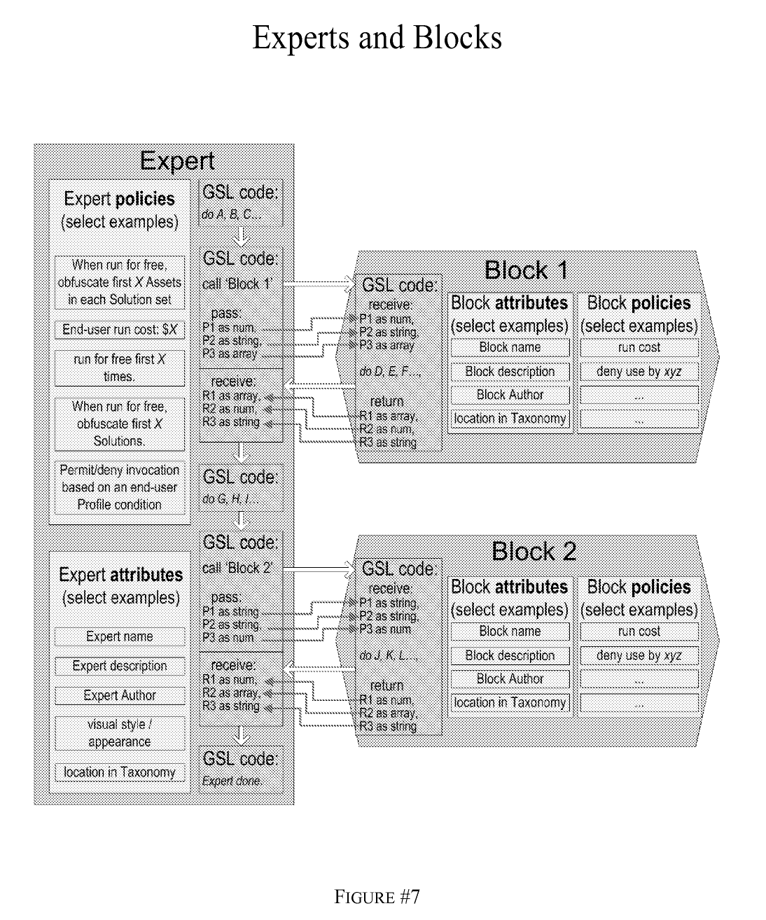

FIG. 7 illustrates a flowchart of one embodiment depicting the relationship between expert programs and blocks. Referring to FIG. 7 in terms of functional execution, a calling Block, or calling Expert-Program module, passes control to the called Blocks. When passing control, the variables and information that the calling Expert-Program module must send as input for the called Block must be of the same type, and in the same order, in which the called Block is requesting and expects to receive them. If necessary, the called Blocks prompt the end-user for the specific input information required for the called Blocks, and by association the calling Expert-Program module, to function properly. Once the called Blocks have completed, the called Blocks return control to the calling Expert-Program module, or calling Blocks. When returning control to the Expert-Program module, the outputted variables and associated information returned to the Expert-Program module by the called Block must be of the type, and in the order expected by the Expert-Program module. Accordingly, it should be understood that in operation, the primary distinction between an Expert-Program module that is being run by the end-user and a Block that is being called to function as a subordinate Block within the Expert-Program module (or a controlling Block) is the way in which each is being controlled. While the Expert-Program module at some point passes control to called Blocks to obtain required information from the end-user, the Expert-Program module ultimately and finally retains control and passes data to the Solution-Engine for solving the problem, or in another embodiment, another platform “logic module.”

In another example, an Expert-Program module dedicated to “Home Theater” may end up calling many Blocks, written by many different Authors, relating to things like cables, connectors, room dimensions, acoustics, components, etc. However, an Author who calls a “Home Theater” Block for use in his own Expert-Program module knows only that he has called the “Home Theater” Block. A collection of logically (and, presumably thematically) connected Blocks, along with some additional shared characteristics, can be combined to form a higher-level Expert-Program module. In this way, simply and easily, “Block-by-Block,” complex systems can be modeled.

Expert-Program modules can leverage the resources and expertise of many individual Authors, all of whom may be experts in small, very granular ways, but none of whom need be (or may be) truly experts in the greater challenge at hand. No complexity is apparent to end-users, who simply interact with a single holistic Expert-Program module. Authors need only have a “big picture” perspective of the problem the Expert-Program module solves and which Blocks to call or create themselves. They can then either write the Expert-Program module with only their own expertise, or break up the problem and the associated expertise into smaller granular pieces, with the expertise for those pieces to be supplied by Blocks; their own or those of other Authors. An Expert-Program module may rely on Blocks by many Authors, all of whom may continue to develop their Blocks while any Expert-Program module that may depend on those Blocks remains available to end-users.

Once made available for execution to end-users, both Blocks and Expert-Program modules remain available to their Authors for continued development. For Expert-Program modules that the Author may create, it is the ongoing responsibility of the Author to ensure that any changes he makes to the Expert-Program module do not result in errors or problems, including the possibility that any such changes he may make may result in errors or problems associated with any Blocks upon which an Expert-Program module relies. However, Authors of Blocks have no such responsibility to the Expert-Program modules that may call them, particularly as these Blocks may be relied-upon by a number of different Expert-Program modules, all of which might be affected differently by any change to a called Block. The potential for “detrimental reliance” on a Block is eliminated by automatically “versioning” Blocks that are called by Expert-Program modules written by other Authors. For example, Author “A” may write an Expert-Program module called “Expert A” which calls “Block B” from Author “B.” The version of Block B called by Expert A may, subject to Author B's discretion, remain available to Expert A, regardless of the changes subsequently made to Block B by Author B. Any such changes to Block B are reflected in subsequent versions of Block B, and every version of Block B which results from such changes may also be safely relied-upon by other Expert-Program modules. By creating new versions of Blocks to reflect changes, and leaving existing versions unchanged, continued development of Blocks is facilitated in a manner which will not “break” any Expert-Program modules which rely upon them. Though Expert-Program modules reliant on older versions of various Blocks will not derive any potential benefit present in newer versions, any Author may elect to update his Expert or Block to rely on and utilize a different version of a called Block, presumably to the latest version, in such a manner that resulting inconvenience to all Authors and end-users is minimized.

While the previous embodiments disclosed Expert-Program modules being created by Authors writing appropriate GSL code, it should be understood that in alternate embodiments, Expert-Program modules may be created by other methods than Authors writing lines of code. For example, in an alternate embodiment, the system may present the Author with a graphical user interface (GUI) through which the Author can define the necessary Assets, Identifiers, Criteria, Interfaces, Connectors, Connector Groups, Connections, and other Author-defined requirements necessary for the system to run properly. In such an embodiment, the Author may input information into the GUI and the GUI translates the input into the appropriate GSL code.

Furthermore, while previous embodiments disclosed the system and Expert-Program modules being written in GSL scripting language, such embodiments should not be read to limit the system or Expert-Program modules to only being programmed in GSL. Accordingly, in alternate embodiments, the system and Expert-Program modules may be written in alternate programming languages that are able to provide similar, or the same, functionality and achieve the same results as the GSL language.

Solution-Engine

In general, Expert-Program modules do not actually provide Solutions. Rather, they refine and frame end-user needs according to the Author's subject matter expertise and the system model. Referring again to FIGS. 2, 9, and 11, once the end-user has finished inputting target values for Criteria as well as the weighted importance values of those Criteria, or confirmed Defaults generated by the system, the Expert-Program module passes control and all information within the Expert-Program module, whether programmed in, acquired from the end-user, or acquired form another source, to the Solution-Engine. The Solution-Engine then analyzes the information passed to it from the Expert-Program module and compares that information to, and correlates it against, potentially the entire collection of Assets represented in the Database. The analysis that the Solution-Engine performs uses complex algorithms and data structures, to deliver the “best” solution(s) in near real-time which best satisfy the unique needs of the particular end-user. This Solution includes at least a set of one-or-more best Assets. Expert-Program modules have little power without the Solution-Engine, and the Solution-Engine cannot deliver best solutions without, at some phase, utilizing the Author's expertise written into the Expert-Program modules.

In another embodiment, the Solution-Engine represents one possible “logic module” among many, each of which may offer different utility. For example, instead of calculating and offering a Solution to end-users representing “best among many” as the Solution-Engine does, in an alternate embodiment, the Expert-Program module may call or pass control to a module representing a different class of processing service, such as content creation. In one such embodiment, for example, after interacting with the end-user, the conclusion of the Expert-Program module results not in a selection from among existing Assets, but in the creation of a new product or service such as a custom specification, which might then represent a new Asset, or be forwarded by the platform to another party for subsequent action.

Database

In addition to the Platform, Expert-Program modules, and the Solution-Engine, the system also includes at least one data storage structure or memory, also referred to herein as a Database. In one embodiment, the Database includes a structure for storing information and data related to Assets. As previously discussed, the Database is a repository that at least contains the collection of all the available Assets within the system that may be outputted to the end-user as at least part of the Solution to any problem which might be effectively modeled by and posed to the system.

Assets

As discussed previously, Assets are generally real-world goods, services, places, methods, etc., or formatted data such as pictures, movie, audio, video etc. Each Asset has associated with it a set of Criteria (i.e. Asset-Criteria) and assigned values for each Criteria that help to define the particular Asset. These Criteria include the characteristics and specifications associated with the Asset. For example, a specific brand and model of television may be an Asset, with every detailed specification about the TV being separate individual Criteria (e.g. screen size, resolution, refresh rate, presence or absence of various connector options, the number and type of each video connector present, the number and type of each audio connector, the manufacturer, power consumption, whether it is EnergyStar approved, etc.). When the Solution-Engine is analyzing the information passed to it by the Expert-Program module, the information received from the Expert-Program module is being compared and correlated against the Asset-Criteria information stored in the Database to determine which particular Asset(s) will best solve the end-user's problem.

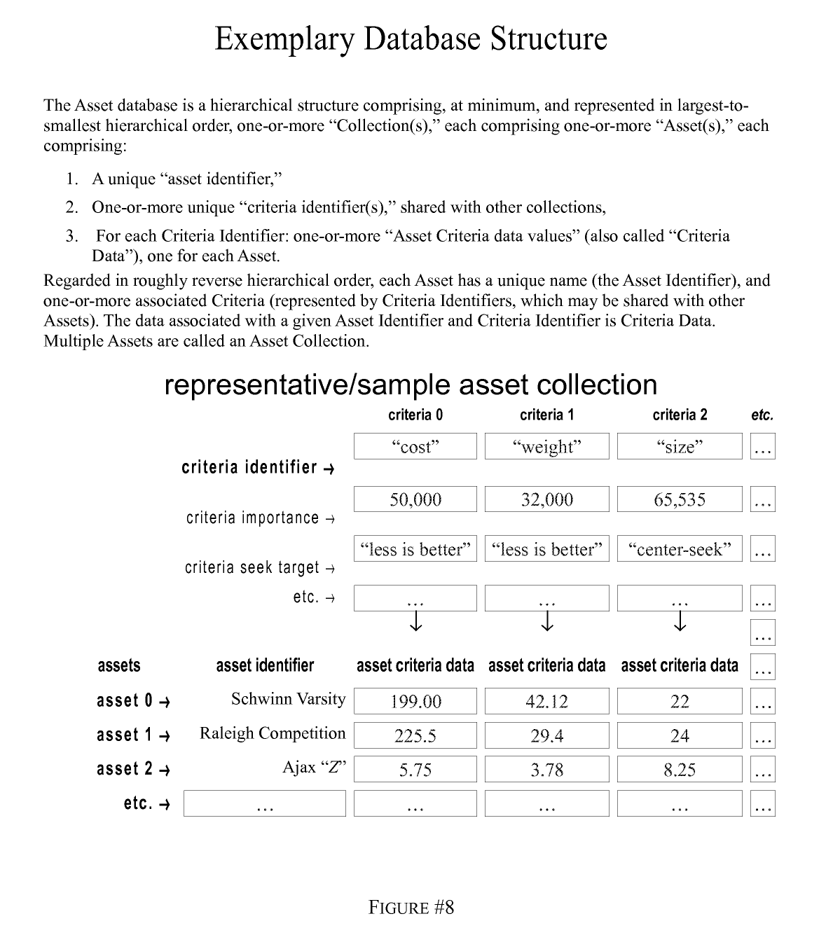

Referring to FIG. 8, one embodiment of a Database record for an Asset Collection in a system incorporating aspects of the present disclosure is illustrated. One or more unique Criteria Identifier(s) are shown, where each Criteria Identifier can be shared with other Collections. In this example, the Criteria Identifiers include “cost”, “weight” and “size.” It will be recognized that in alternate embodiments, any suitable Criteria Identifiers can be utilized. In this example, each Asset is provided with an Asset Identifier and one or more Asset Criteria data values, where each Asset Criteria data value corresponds to a Criteria Identifier. The example further represents, for each Asset Criteria, an associated Importance Level, and a Seek Target for illustrative purposes. However, it should be noted that Importance Level and Seek Target differ from Asset Criteria data values—which are generally static—in that Importance Level and Seek Target parameters are typically dynamically adjusted by the Expert-Program module in the normal course of generating an ideal Solution for each distinct end-user.

In addition, the Database and the corresponding information stored therein is also fully searchable. Individuals can utilize the platform's interface to access the Database and use search terms to search for specific Assets. In addition, individuals can alternatively search through the Database using a hierarchical, taxonomy-based expandable tree structure, or other similar graphical or text based selection interface.

OEM/OSP

For specific Assets, the collection of information that makes up each Asset's Criteria can be entered into the database by anyone. For products, services, etc. that are not yet loaded into the Database, it may likely be the original equipment manufacturer (OEM), original service provider (OSP), or otherwise the provider of the Asset who enters the Asset-Criteria information into the Database. However, in alternate embodiments, Assets and their Asset-Criteria may be entered in to the Database by retailers, re-sellers, or any other party, including Authors themselves. The above disclosure should not be read to limit who can load new Assets in the Asset Database. In addition, the system allows third-party web content providers to tag information in a manner consistent with the system's programming, which can then be searched for and found in the same way that traditional web search engines find information on the Internet. For websites that include tags that are compatible with the presently disclosed system, Assets and all associated Asset-Criteria can automatically be entered into the Asset structure of the Database without needing any other sourcing activities to be performed by other parties.

In alternate embodiments, additional structures may also be optionally included in the system's Database. One additional structure that may be included is a structure for storing information on OEM's, OSP's, and other such similar Providers of Assets. Such a structure can include any Criteria that the OEM, OSP or Provider believes may be relevant to an end-user in deciding from which source to obtain the resulting Assets that are output in the Solution. Such Criteria can include more obvious things such as Asset cost, location of the provider, whether they offer delivery, and if so, what the delivery costs are, etc. However, the Provider Criteria can also include more abstract Criteria, such as whether a Provider has a good reputation for environmentally responsible business philosophy and track record, whether the Provider has a reputation for providing quality customer service, fair hiring practices, etc.

Expert-Program Modules

In another embodiment, the Database also includes a searchable Expert-Program module structure, which contains an index of all available Expert-Program modules as well as the individual executable Expert-Program modules themselves. Similar to the Asset structure of the Database, the platform's interface allows the end-user to search the Database's online Expert-Program module structure, using normal phrase searching, to find an appropriate Expert-Program module that can address the end-user's problem. In alternate embodiments, individuals can search through the Expert-Program module structure of the Database using a hierarchical, taxonomy-based expandable tree structure, or other similar graphical or text based selection interface. End-users are also able to use their Expert-Program module search results to view other end-user ratings given to individual Expert-Program modules, read end-user reviews, and view other statistical data associated with particular Expert-Program modules. In this manner, end-users can see which of the Expert-Program modules in a given subject area have been given higher or lower ratings, which provide better results, or are more reliable in terms of the quality of Solution provided. Such information may be very useful to the end-user.

End-User Profile

In another embodiment (particularly in embodiments utilizing a web-based platform), the database may include one or more end-user Profiles. The end-user Profile is (for each end-user) a private collection of associated personal characteristics describing the end-user's preferences, status and history, all of which can be used within the system as Profile-Criteria to help determine optimal solutions to end-user problems. Some examples of the type of information a Profile may contain include traditional demographic information such as the end-user's personal information (e.g. age, sex, height, weight, occupation, residence, financials, etc.), preferences (preferred retailer, payment method, delivery method and time, etc.), a history of the particular Expert-Program modules the end-user has run, Solutions that have been generated, reviews of Assets recommended in Solutions, Assets purchased, and other pertinent information, historical or otherwise.

End-users may enter Profile information when first registering on the system, in the natural course of interacting with Expert-Program modules, or at generally any other point in time. For example, any event for which the outcome depends on, or is affected by, Profile data can prompt the end-user to input such data if it is not already a part of the end-user's Profile. Once the end-user enters the data, it is incorporated into their Profile.

Additionally, in one embodiment noted below, when end-users adjust Primacy-driven, Profile-related settings, their end-user Profiles automatically incorporate these adjustments. In this way, end-user Profiles remain updated and accurate.

It should be noted that in an embodiment of the system, end-users are not required to complete a Profile to operate the system, or log-in to be personally recognized. Solutions can still be generated without an end-user Profile. However, if no end-user Profile is available, the Expert-Program module will not consider any of the detailed personal information that is usually collected within a Profile. However, in an alternate embodiment, when no Profile exists for an end-user utilizing the system, the end-user is notified that no Profile exists and the system will give the end-user the opportunity to enter the relevant information usually contained in a Profile. If the end-user enters such information or completes a Profile, then the ability to correlate end-user Profile-Criteria is immediately available for the generation of Solutions.

Market Research Data

In another embodiment, the Database may include Market Research data reflecting information on all end-user activity, including (but not limited to) adjustments to Criteria data and importance values, individual Assets recommended for every Solution, end-user purchase details, etc. The relationship of such activities to specific end-users can be maintained, and correlated with data from end-user Profiles. Such specific, and specifically-correlated information forms the basis for Market Research data, which can provide feedback to market research companies, Providers, OEMs/OSPs, and other parties in ways which may direct future available Assets. While the end-user activity information is correlated with end-user Profiles for Market Research data, end-user identity typically remains private. However, the value of such Market Research data is not undermined by maintaining the privacy of end-users' personal identity.

Primacy

Application

In another embodiment, end-users rate the Expert-Program modules they have run, Assets they have purchased, and other resources they are able to evaluate through personal experience, and enter those ratings into the Database. These ratings, which reflect the specific “How good is ‘X’ for me?”relationships between individual end-users and the items they rate, form the basis for determining “Primacy.” Primacy differs distinctly from “reputation;” the basis of reputation being an inherent quality which is not intended to be personally and specifically connected to the end-user or party evaluating the item under consideration.

The system correlates ratings and previously-determined Primacy with individual end-user Profiles and (factoring similarity) other end-user Profiles in order to predictively determine how favorably resources will likely be received by any specific end-user. The system's ability to predict end-user-specific appeal is called “Imputed Primacy.”

For example, the system may take into consideration the end-user's age, sex, and residence to help determine the best purchase options for someone who is, for example, 35 years old, male, and lives in a high-rise in Chicago. The needs associated with an individual having those Profile-correlation Criteria may be significantly different than the needs of someone who is 75 years old, female, and lives in a ranch home in rural Nebraska. Accordingly, a given Expert-Program module may offer different Solutions to different end-users, even if they have entered the same Selection-Criteria target values and importance values, simply because the Profile-correlation Criteria contained in their individual Profiles is significantly different.

To aid the system in making accurate correlations between the information in end-user Profiles and the most optimal solutions, in yet another embodiment of the system disclosed herein, the information associated with end-user Profile-Criteria for all end-users is also collected and stored within the Database in a separate Profile structure. The Profile-Criteria can be used by the system to consider Criteria that the Author may not take into account, and adjust the recommended Solutions accordingly. Such Criteria includes anything that would be contained in an end-user Profile. The system is capable of analyzing the ratings information within the Database, calculating statistical information on, among other things, which specific Assets have proven to be better Solutions for end-users, and selectively correlating this information with end-users falling into various categories and demographics. This too is part of the Imputed Primacy capabilities of the system. The system can then use this calculated statistical information to adjust the various importance values within the Expert-Program modules and provide improved recommended Solutions. For example, if the system analyzes the ratings information associated with Profiles and calculates that 96% of all men between the ages of 35 and 40 have been most happy with a specific Asset ‘X’ instead of Asset ‘Y’ for the Solution to a specific problem, the system can account for this statistical significance and adjust the recommended Solution accordingly.

Imputed Primacy can be referenced within an Expert-Program module to further guide the Solution-Engine in delivering a “best-possible” Solution to individual end-users. In one embodiment, Imputed Primacy may be used to determine and set Defaults to be used to solve the problem for that particular end-user. Such Expert-Program module generated Defaults, which are based on the Author's specified rules and relationships expressed in the Expert-Program module, can thereby be adjusted to reflect changes in end-user Profile-Criteria without additional Author involvement or consideration beyond the initially-specified rules and relationships. For example, Imputed Primacy, based on an end-user's Profile data, may be used by an Expert-Program module to reduce the importance of Criteria “X” and increase the importance of Criteria “Y,” because the end-user satisfies a specific condition or set of conditions. If the Expert-Program module allows for it, the end-user may then accept the Primacy-driven settings presented, or adjust them as necessary.

Expression

For example, within the GSL programming language, one embodiment defining the Imputed Primacy for brands of electronics, based on end-user age and gender, might be expressed as:

```
begin impute primacy
  name = brand, for electronics, by gender and age
  importance = 7
  calculation = average
  begin correlate
    graysilk|[executing end-user]|profile|gender = female
    graysilk|[executing end-user]|profile|age = range 20 to 30
    everything electronic
  end correlate
  period = 1 year
  apply = identifier|brand
end impute primacy
```

In the above exemplary format, “name” defines the logical label by which this specific Imputed Primacy can be referenced elsewhere in the Expert-Program module. In this example, the specification of “brand, for electronics, by gender and age” as the “name” indicates this piece of programming for Imputed Primacy may be referenced by this label elsewhere in the Expert-Program module. “Importance” defines the degree of influence with which the Primacy definition should affect the Solution. The specification “7” indicates this influence should be to this degree, on a scale which is defined elsewhere in the Expert-Program module. A value at the top of this scale (e.g. “10” on a scale of 1-10) indicates that no other consideration of Primacy, during this phase of operation in the Expert-Program module, can be considered more significant. In another embodiment, terms may be specified by the Author to indicate “scope of influence” for the construction, either “local,” or persistently affecting subsequent computation. “Calculation” indicates the approach used to determine a combined rating figure from other end-users. The specification “average” indicates a numerical average should be applied, but in other embodiments, other mechanisms such as mean and median, or other such statistical analysis may also be used.

Contained within the block of programming between the “begin correlate” and “end correlate” lines are references to different conditions that are “logically true,” if those conditions are met during their evaluation. In the exemplary format, if a Profile data reference matches the Profile data of the end-user running the Expert-Program module, that condition is true. If a previously-defined condition identifies “everything electronic” and an item consistent with this definition is being evaluated, the “everything electronic” condition is also true. The complete block of programming is “logically true” to the extent that the individual terms specified therein are all “logically true.” This represents the implied application of a logical “and” operator to these conditions, but in another embodiment, other Boolean operators (e.g. “or,” “not”) may be used, as well as the specification of importance values to the individual terms within the “correlate” block of programming.

Continuing with the above example, “system|[executing end-user]|profile|gender=female” may be read: “If, according to the Profile of the end-user executing this Expert-Program module, the End-user is ‘female,’ this specific condition is ‘true.’” Similarly, “system|[executing end-user]|profile|age=range 20 to 30” may be read: “If, according to the Profile of the end-user executing this Expert, the age of the end-user is ‘between 20 and 30 years of age,’ this specific condition is ‘true.’” “Period” indicates the time frame within which ratings are to be considered. In the exemplary format, “period=1 year” indicates that only ratings issued within the previous year from the date on which the Expert-Program module is run are to be regarded.

Completing our example, “Apply” references the Criteria on which Primacy is to be asserted. In the exemplary format, the specification “identifier|brand” indicates the Criteria “brand.” This construction will therefore aggregate ratings from similar end-users (those whose Profiles indicate they are female, and between the ages of 20 and 30) issued to “everything electronic,” but only those ratings which have been issued during the past year. These ratings will be averaged, and this average rating will be applied by the Solution-engine as a factor when considering “brand.”

As a summary example, if, during the past year, women between 20-30 have rated “Apple” brand electronics, on average, “8” (on a scale of 1-10) and “Sony” brand electronics an average of “4” during the past year, the above example specifies that when a same-age and same-gender end-user runs an Expert-Program module with this construction, the preference for any electronic Apple product will be asserted as “8,” and the preference for any electronic “Sony” product will be asserted as “4,” such preference expressed overall with an importance of “7.” With such an embodiment, the system is dynamic in that the Solutions and the associated Assets recommended as part of the Solution can continuously evolve and improve as additional data is collected.

### EXAMPLE

### Home Theater Expert-Program Module

Disclosed below is one example of an Expert-Program module written in the GSL language for problems and queries related to “home theater systems” (e.g. an example of an associated problem for which this may be used includes the identification of the best receiver to purchase when the end-user already owns a specific TV and Blu-Ray player).

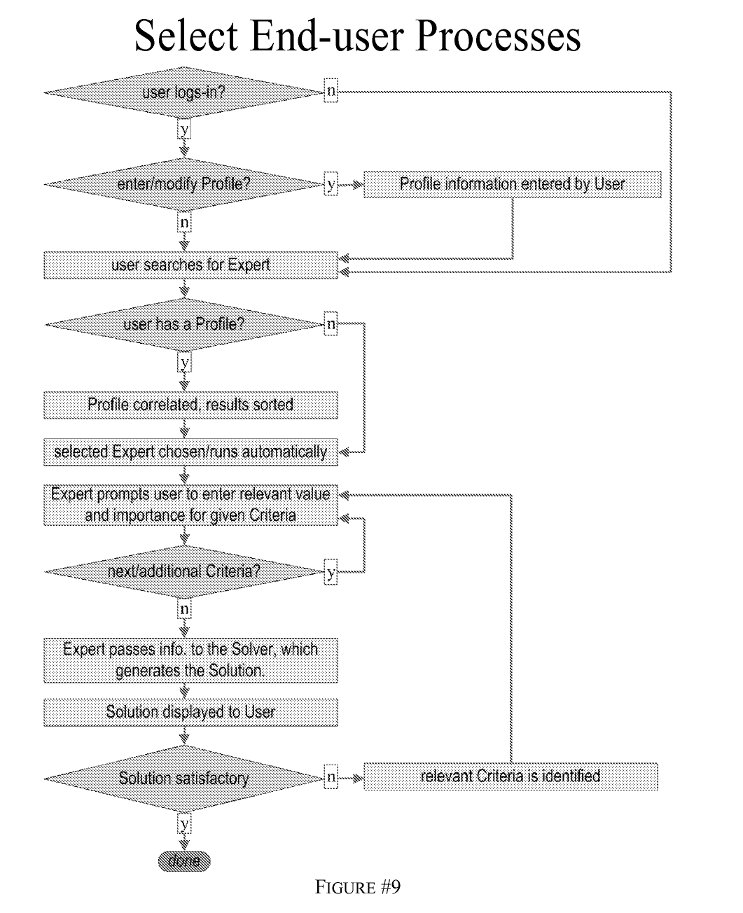

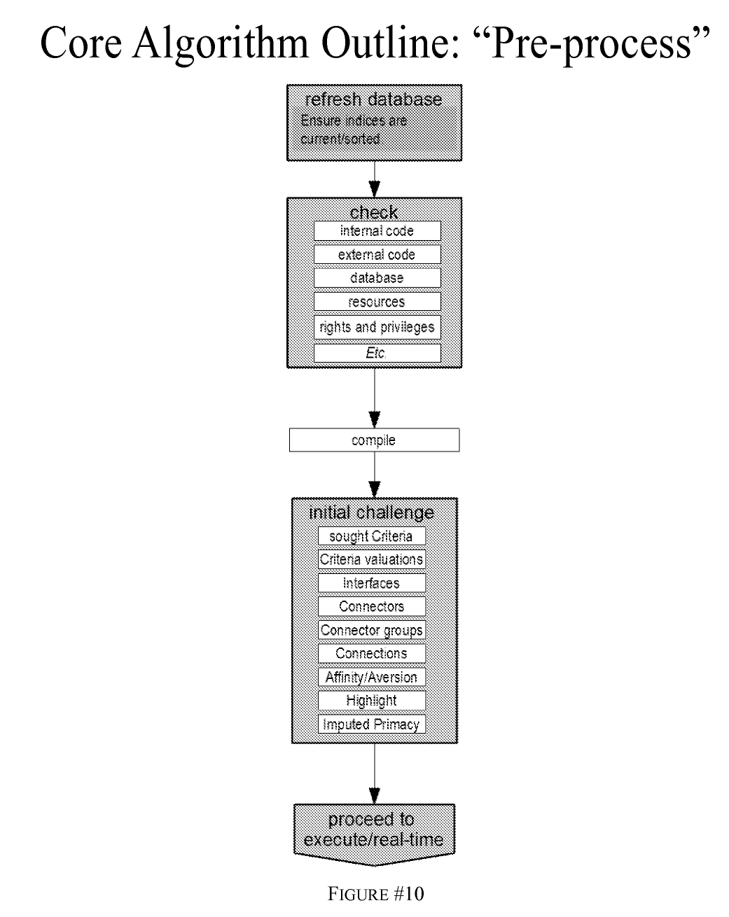

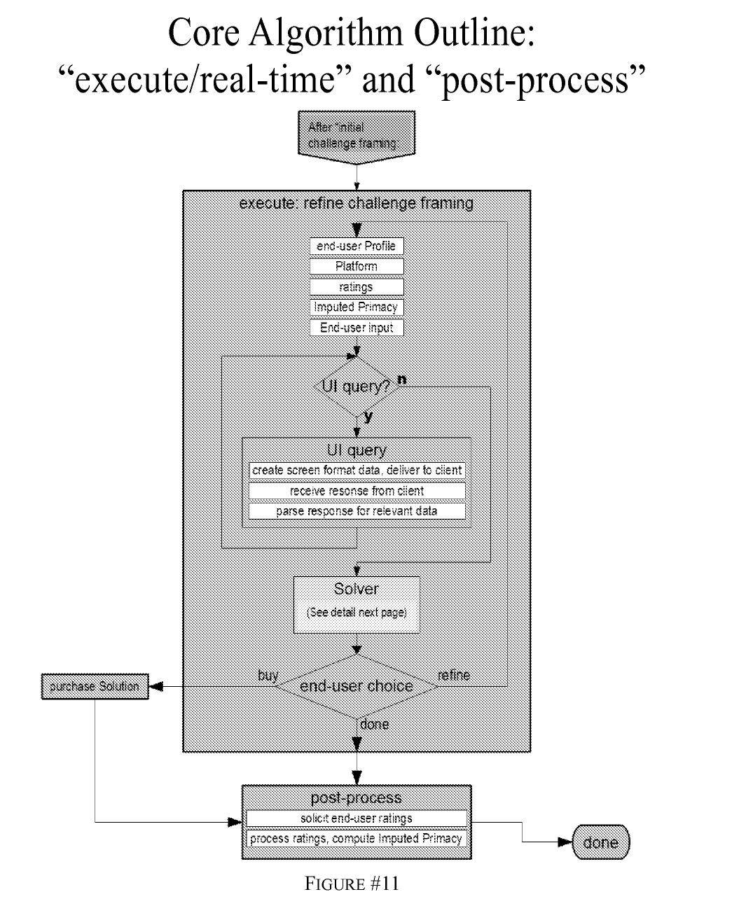

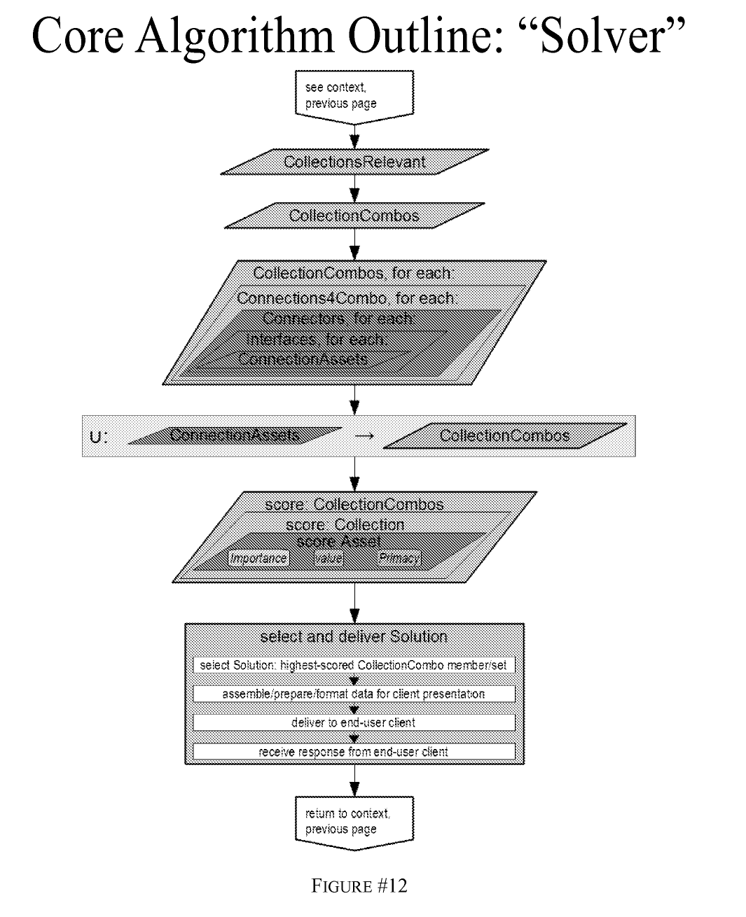

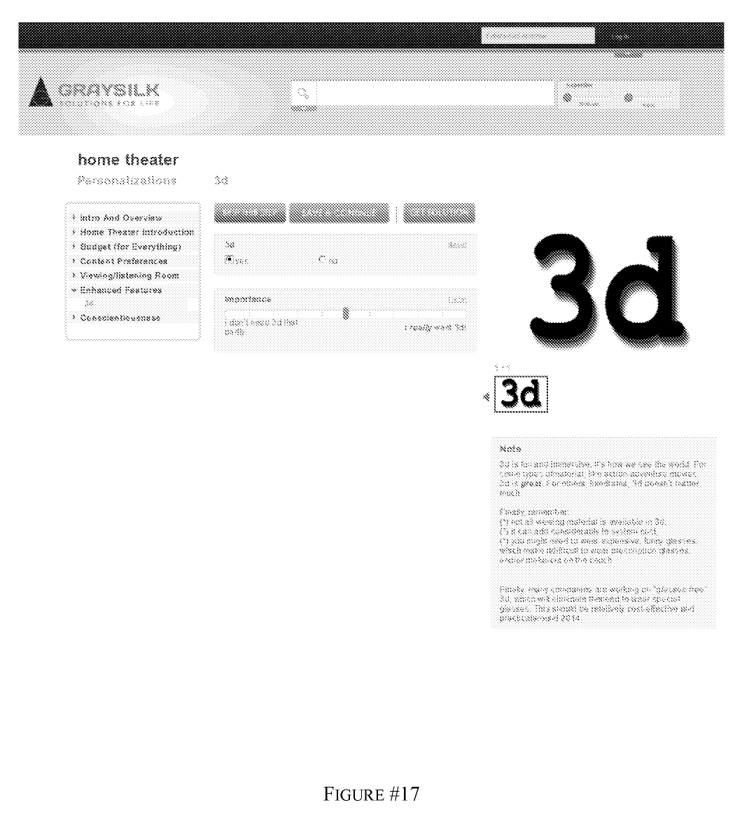

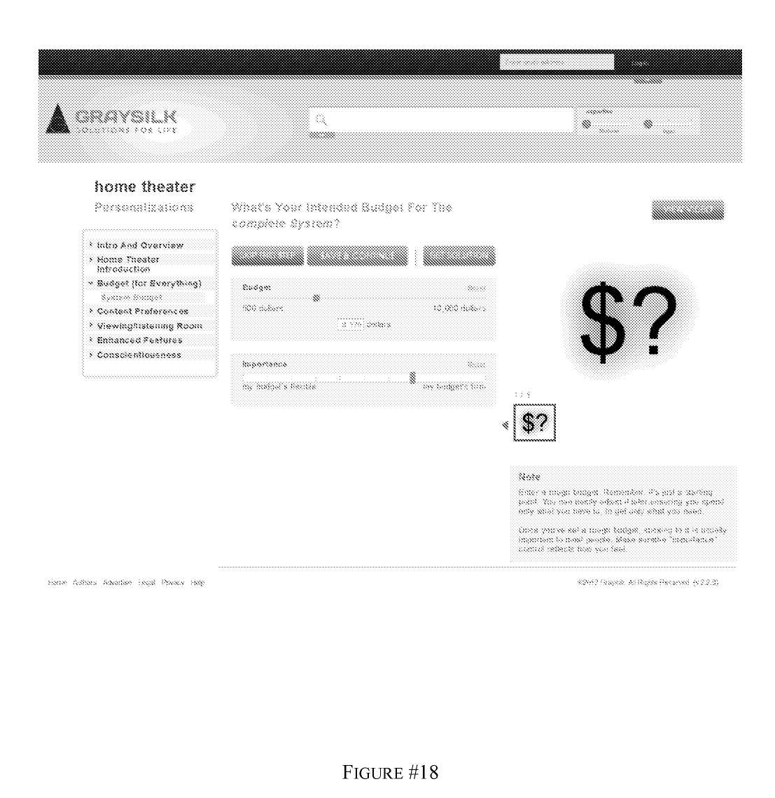

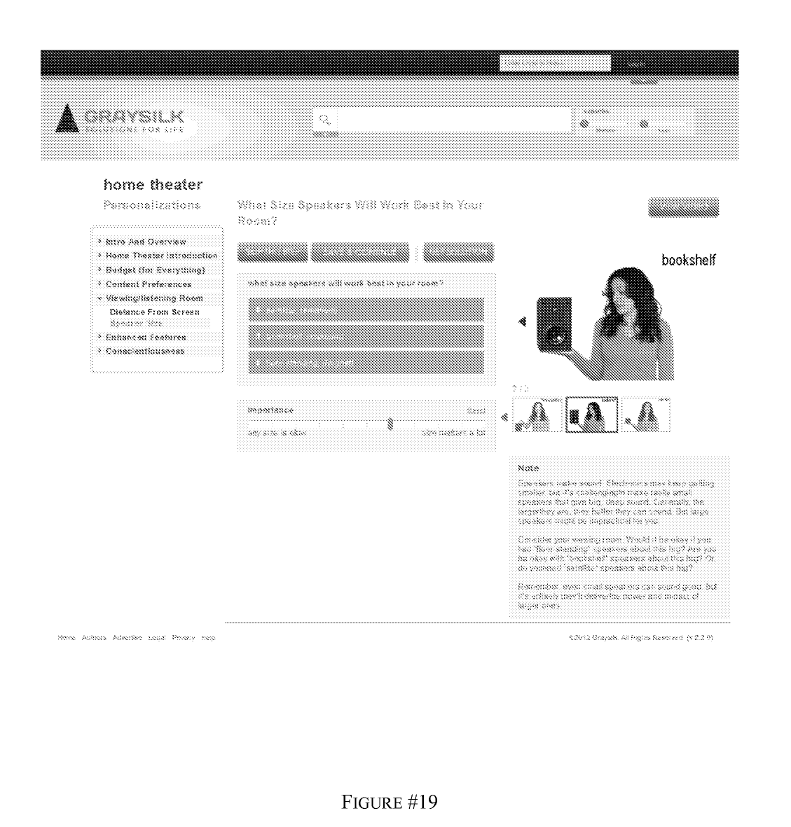

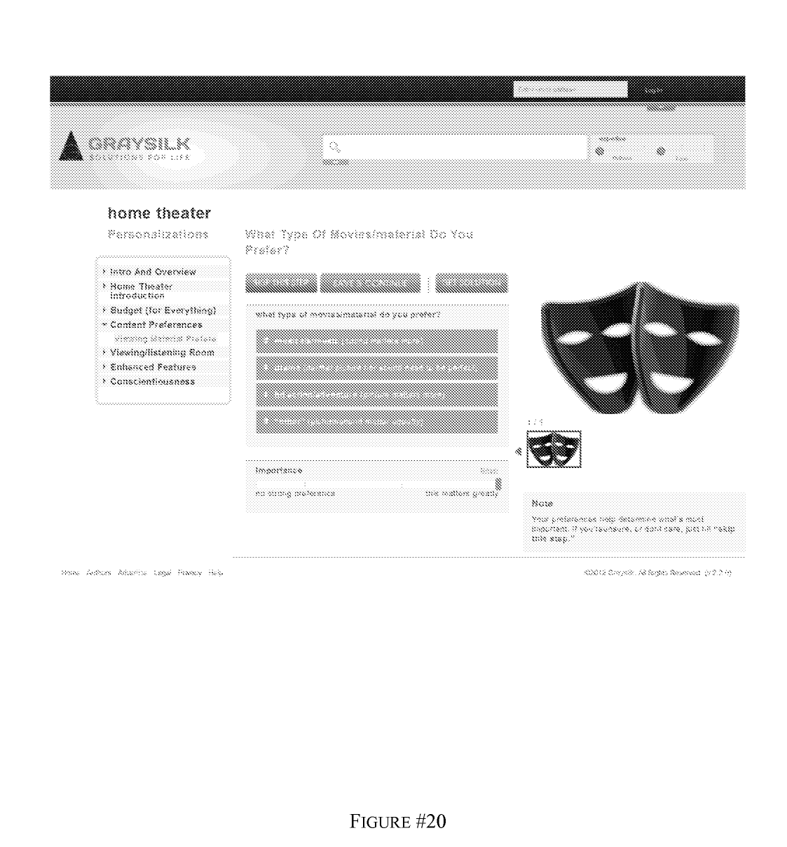

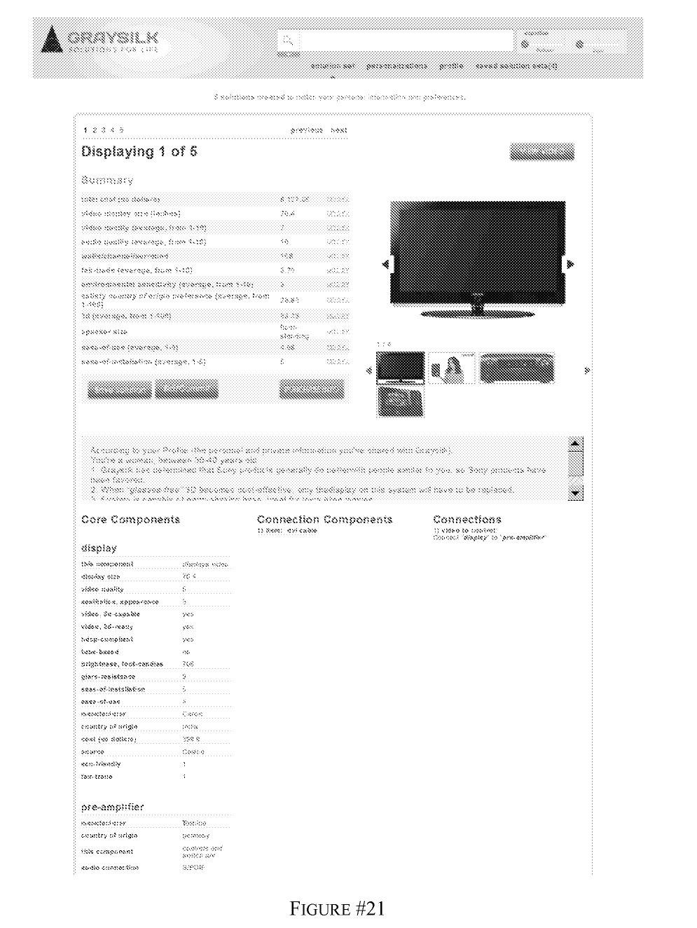

The below example is a representative product of one embodiment of Author Processes as represented in FIG. 4, embodying the connectivity hierarchy as represented in FIG. 5, supporting end-user processes as represented in FIG. 9, describing and presenting user-interface screens as represented in FIGS. 17-20, following the overall processes represented in FIGS. 10-11, computing a Solution as represented in FIG. 12, and delivering that Solution to an end-user as represented in FIG. 21.

In the following example, carriage-return/newline character(s) have been preceded by the “¶” character to distinguish formatting line breaks (i.e. to fit this printed page) from “logical end” of each line (i.e. where the line would break if more display columns were available). Additionally, “whitespace” (e.g. blank lines, and tab and space characters which may appear on a line before other text) are generally intended to aid readability, and are not logically significant. Finally, the inclusion of copious explanatory (i.e. non-executable) notes in code is both common practice and good form. However, such notes are excluded in the following example for purposes of brevity.

System Operation

Referring to FIGS. 2, 4, 9 and 10, in operation, the system functions as follows. In a pre-execution phase, an Author creates one or more Expert-Program modules or Blocks as described above, which conveys an Author's expertise in one or more subject areas, to address end-user problems related to that subject area. Although the aspects of the disclosed embodiments are generally described with respect to a one-to-one correspondence or relationship between an Author and an Expert-Program module, in one embodiment, the relationship can be one-to-many, where a single Author creates more than one Expert-Program module, as is generally described herein. In writing the Expert-Program module, the Author uses GSL (or another similar programming language) to specify the relevant Selection-Criteria and their default target values, all Interfaces, Connectors, Connector Groups, and Connections, as well as the rules and relationships there between, which the Author determines are relevant to the needs of end-users in the determination of the best solution to the problem. The Author also specifies the rules for determining the Default values of each Criteria and sets the level of importance for each Criteria. If the Author requires additional or different expertise to address one or more discreet pieces of the problem, he may program his Expert-Program module to call up and use other Blocks containing the desired expertise. The Author writing the Expert-Program module may call up Blocks that he has authored himself, or Blocks written by other Authors. Blocks may be called for any number of reasons, including an Author requiring expertise in a subject area that is beyond his own scope of knowledge, or an Author having previously written a Block that encompasses the required expertise. Each Expert-Program module can be as detailed as its Author desires. The Expert-Program module may be broad and high-level, covering just a few aspects of multiple sub-topics within a subject area, or very granular, and covering every minute detail of the subject area and sub-topics.

Once the Author has confirmed that the Expert-Program module can be properly executed using the Solution-Engine within the system, and that the Expert-Program module will provide complete and appropriate Solutions, then the Expert-Program module is saved to the Expert-Program module Database within the system and made available within the system for use by end-users.

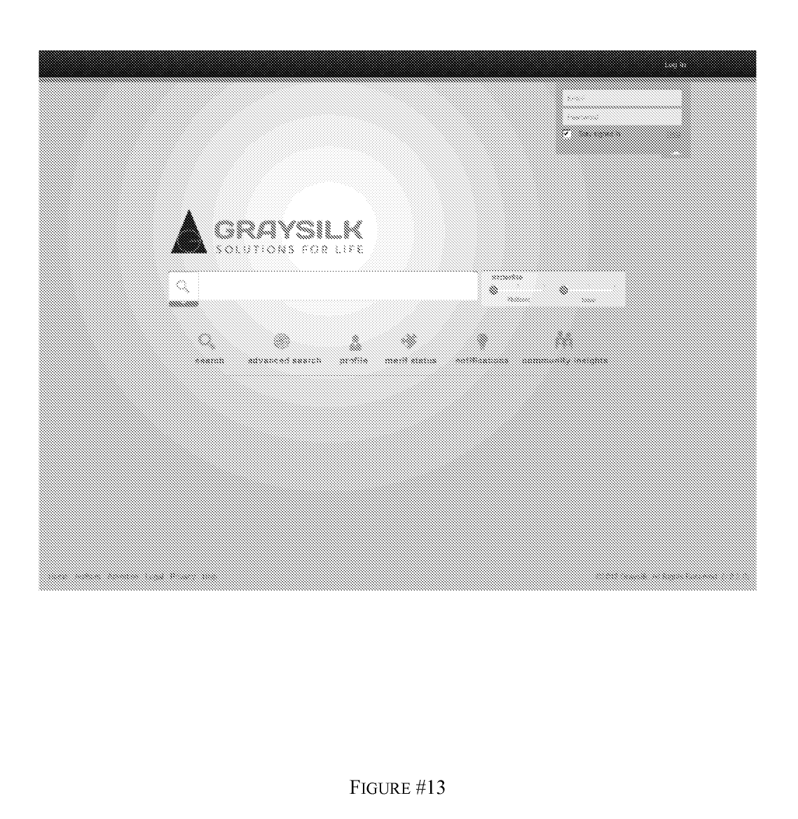

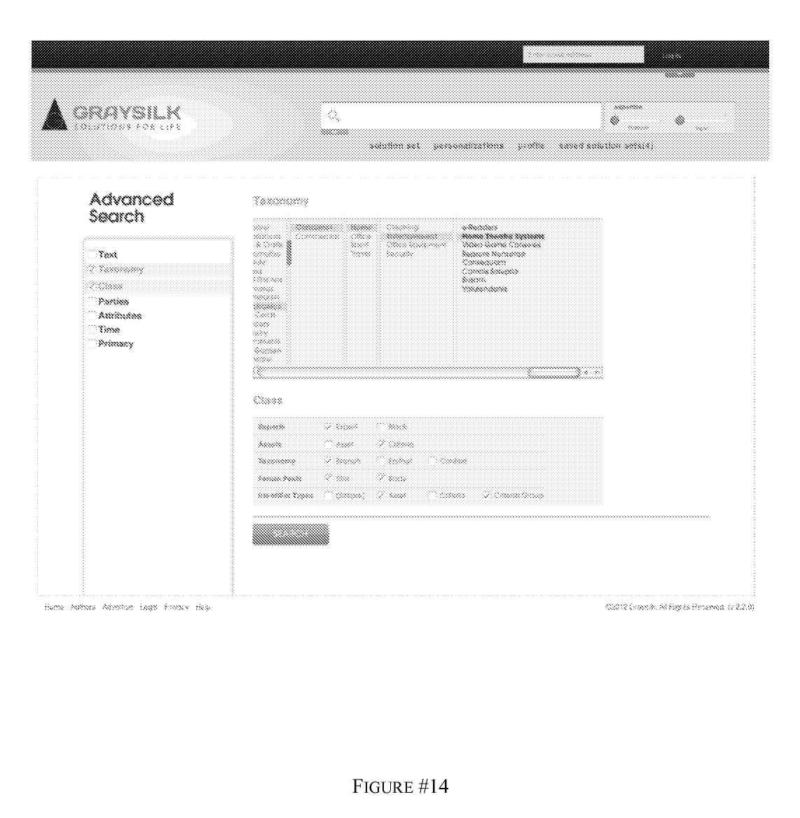

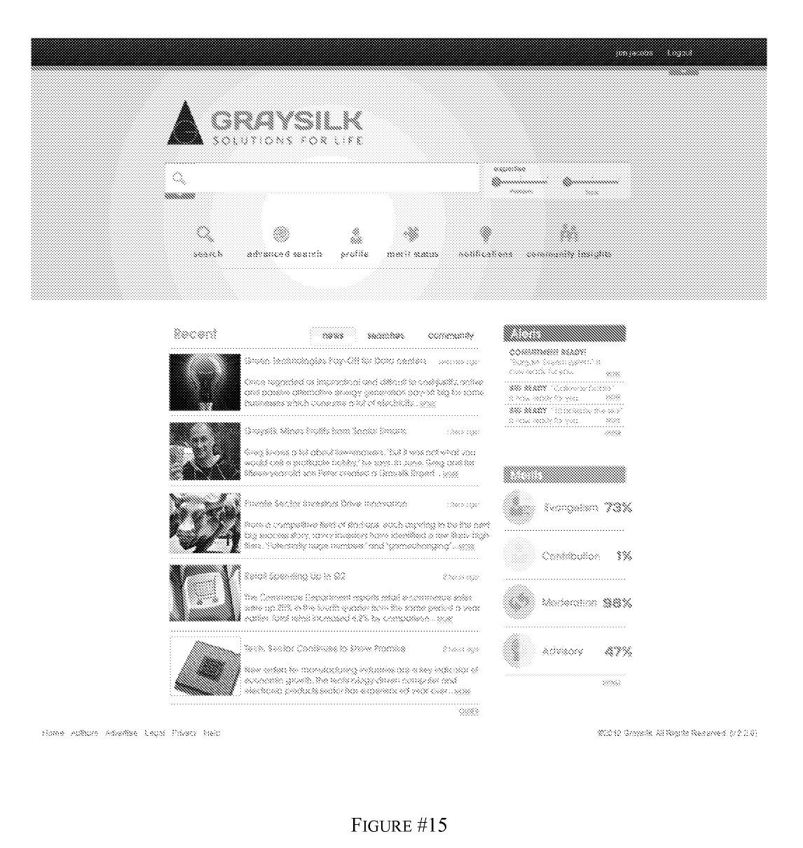

Referring to FIGS. 2, 9, 11-13, in one embodiment, an end-user calls up the system platform and, if desired or required, logs-in to the system. In one embodiment, if an end-user does not log in (thereby connecting with a specific end-user Profile), he will be taken directly to an Expert-Program module search screen (see FIGS. 13 and 14). If the end-user does log-in, he will first be taken to a system Home screen (see FIG. 15). Once logged-in, the end-user may choose to create, or modify, his end-user Profile. The system recognizes whether a logged-in end-user has a Profile and can use the information contained therein to help arrive at Solutions. The end-user then uses the search screen to search for and select an Expert-Program module that is appropriate for the problem to be solved (see FIGS. 13 and 14).

Referring to FIG. 13, in one embodiment (e.g. a beginner mode), the end-user can simply input a keyword(s) related to the problem-to-be-solved into a search screen and the system will automatically return and execute the Expert-Program module the system has identified as the most appropriate, via Imputed Primacy and/or ratings from other end-users, thereby delivering a Solution to the end-user with no basis other than the searched-for keyword.

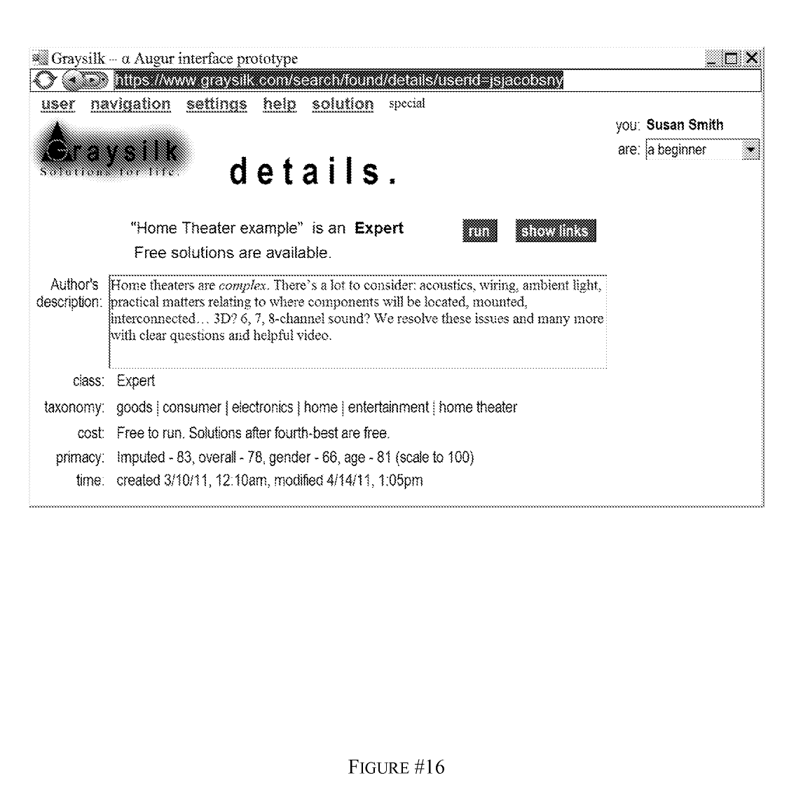

Referring to FIG. 14, in another embodiment (e.g. an advanced user mode), the end-user may run a more complex phrase search for an appropriate Expert-Program module. Alternatively, the advanced end-user may drill down through a hierarchical, taxonomy-based expandable tree structure, or other similar graphical or text based selection interface, to see the list of all Expert-Program modules that are available for selection, and which address his problem. Referring to FIG. 16, the results of an Expert-Program module search can be optionally displayed on a search results screen, where the end-user can review pertinent information about the specific Expert-Program module, such as a description of the Expert-Program module written by the Author, the cost to run, the Primacy, and other relevant information. Referring to FIGS. 17-20, once selected, the end-user interfaces with the completed Expert-Program module via a GUI, or other similar interactive interface. The Expert-Program module prompts the end-user to input information necessary for the system to generate Solutions to the problem. The information requested may include, among other things, target values for the Criteria previously specified by the Author as being relevant to the subject-matter and the end-user's problem, as well as weighted values indicating the importance of each of those Criteria to the end-user. Entering this information, or merely confirming the defaults generated by the system based on the rules set by the Author, allows the system to identify what the end-user is seeking in the way of Criteria target values and how important each Criteria is to the Solution, within the context of the end-user's specific problem. If the end-user has no opinion as to what value to input for any particular Criteria, the end-user can rely on the expertise of the Author and accept the default value input by the Author. If a particular Criteria is not even a consideration the end-user cares about for the problem at hand, the end-user can set the weighted importance value as low as possible and that Criteria will be given very little consideration in the determination of a Solution.

Once the Expert-Program module has finished prompting the end-user for input, and the end-user has entered all of the information that the he would like considered by the system in determining an optimized solution, the Expert-Program module passes the collected data and control to the Solution-Engine. The Solution-Engine analyzes the data inputted into the Expert-Program module (Criteria, target values, importance values, Interfaces, Connectors, Connector Groups, Connections, etc.), the end-user Profile-Criteria, and the data in all other relevant resources to identify all potentially relevant Assets contained in the Asset Database. The Solution-Engine applies the relationship model to the relevant Assets and forms groups representing viable Solutions. Next the Solution Engine evaluates then orders the Asset groups according to the Criteria values and importance values.

Referring to the flowchart of FIG. 12, in one embodiment, the Solver or Solution engine is configured to create a set of Asset Collections based on the data inputted from the Expert module. Each Collection contains members that might contribute to the Solution. The “CollectionCombo”, or set of “CollectionCombos”, can represent the set of Collections that might represent the core Solution.

For each of set of the CollectionCombos, the Connectors, Interfaces and Connection Assets for each are resolved. The two sets are then joined so that each CollectionCombo member represents a set that satisfies both core and connectivity requirements. For each CollectionCombo member, a normalized score is computed and a best Asset score is recorded for each, according to importance, data value and Primacy, for example. The combined Asset scores represent the score for each member of the CollectionCombo set. In one embodiment, the best-scoring member of the CollectionCombo set is selected as the Solution, and the associated data is delivered to the end user.

Referring to FIG. 21, when the Solution-Engine has finished analyzing the information passed to it by the Expert-Program module, the system outputs its recommended Solution to the end-user. The recommended Solution is determined by the Solution-Engine operating on the Assets, Criteria, target values, and importance values fed to it by the Expert-Program module, as well as all relevant information contained in any other available database (e.g. Provider Database, Profile-Database, etc.). In alternate embodiments, the system may output a list of the best possible Solutions, a “Solution Set,” which is generally ordered from the best to the worst Solution. The number of Solutions in the Solution Set, can be determined by either the Author or end-user, or can alternatively be a fixed number as determined by a system administrator. If the end-user is not satisfied with the Solution that has been recommended by the system, the end-user may backtrack to an earlier point in the input process, refine his input parameters, and re-run the Expert-Program module until a satisfactory Solution is presented.

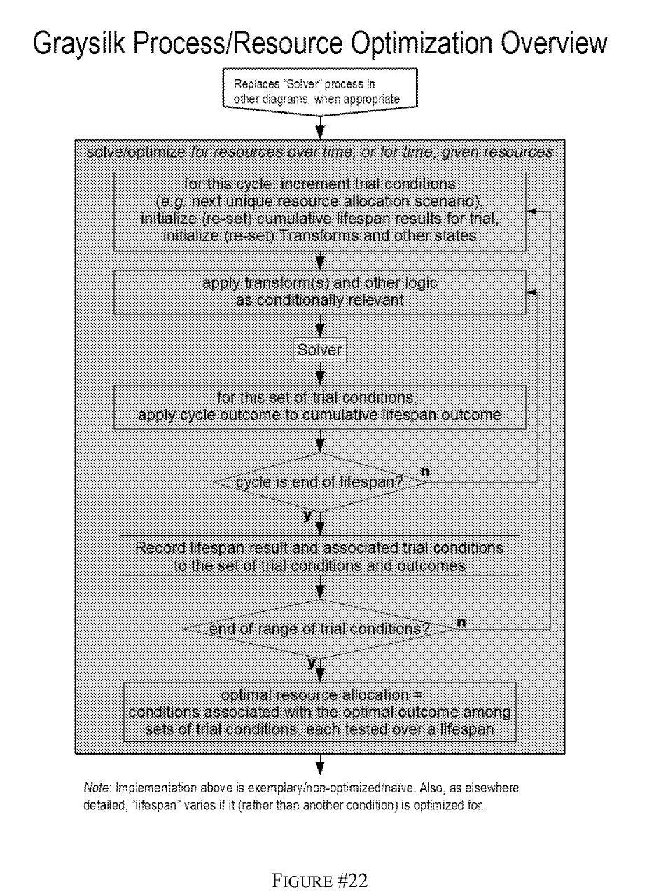

Referring to FIG. 22, when the Expert-program incorporates mechanisms for the consideration of time, in one embodiment, the Solution-Engine may, as outlined in FIG. 22, apply processes such as those detailed herein in a manner reflective of aforementioned model time expression mechanisms such that a Solution may reflect successive invocations of the Solution-Engine and such a Solution may reflect the optimal result of multiple preliminary Solution-Engine processes.

Solutions

Each solution (i.e. one-or-more goods/services/items sought by the end-user) that is outputted to the end-user comprises at least identification and/or allocation of one or more Assets that were programmed into the Asset Database. For example, a problem may involve the end-user trying to select the best possible stereo receiver to purchase, based on various preferences he has for particular brands, connection options, watts-per-channel, etc. (i.e. the specified Criteria, target values, and weighted importance values that are applied to each Criteria). Those end-user preferences would be inputted into the Expert-Program module and used to generate a Solution specifying which of the stereo receivers (i.e. the Assets) that are represented in the Asset Database is the best stereo receiver for the end-user.

In addition to Solutions comprising one or more Assets, the Solution presented to the end-user may further comprise additional information useful to solving the end-user's problem. In one embodiment, if the platform is web-based, the system may be able to search the Internet to identify, in real-time, the best available price at which the Asset may be purchased and provide this information as part of a Solution. Moreover, the Solution may also optionally include a list of Providers (e.g. merchants, retailers, service providers, individual people, etc.) from which the Asset is available for purchase, at that best identified price. In addition, as part of the Solution, the system may act as a portal to facilitate the ordering of, and payment for, Assets from the identified Providers, thereby transferring the order to the chosen Provider.

Future Solutions—Bid/Commit/Notify

As disclosed in embodiments above, the system is able to achieve the goal of generating Solutions that are the best available right now. Accordingly, with these Solutions, end-users are able to purchase Assets that both satisfy their needs and currently exist in the Database, and accordingly, the marketplace. However, in alternate embodiments, if the end-user is not satisfied with any of the currently available real-world Solutions that are generated by the system, the end-user may also request that the system generate optimized Solutions that include Assets that, for any number of reasons, are not yet available in the real-world. For example, a given Asset may have all of the feature Criteria an end-user requires, except that the Asset costs considerably more than the end-user is willing to pay, and the cost Criteria happens to be the most important Criteria to that end-user. Accordingly, due to the cost Criteria, there would be no Asset currently available in the Asset structure of the Database that satisfies the end-user's needs.

As disclosed above, the system performs an analysis of the inputted Criteria, target values, and weighted importance values to determine what Assets provide the optimized solution to the end-user's problem. If no Assets currently exist to satisfy the end-user's needs, end-users can notify the system that no Solutions are currently acceptable. End-users are able to indicate to the system that they are willing to delay their purchase of presently available Assets until Assets that better fulfill their needs become available in the future. The system will then record that unmet need, including the specific combination of Criteria desired by the end-user, for later use by providers of Assets.

The system can track the specific Criteria, or combinations thereof, which cannot currently be found in the current marketplace, but that would otherwise be ideal Solution components to solve end-user's particular problems. When demands for unmet Solutions and their associated Assets are aggregated, the system essentially creates a new market for both theoretical Assets that do not yet exist and Assets that do exist, but that for some reason (e.g. price) are not acceptable Assets as part of Solutions (collectively “future Assets”). Providers can then utilize the system to interactively review those unmet needs as well as assess and explore the present value and demand of any theoretical Assets they may define/create, or Assets they may redefine. Redefining an Asset might include simply changing the value associated with any Asset Criteria (e.g. cost, size, etc.), or creating a new Asset with completely new Criteria. In other words “If I am able to provide Asset ‘X’ at price ‘Y,’ how many can I immediately sell?” or “If I create new Asset ‘Z’ that has these Criteria and associated values, how much can I sell it for?” In this manner, Providers can use the system for additional market research to gauge consumer interest in new future Assets. If the future Assets that fulfill those unmet needs do become available from Providers, the end-users are notified and may then purchase those Assets.

In practice, to indicate his interest in a future Solution comprised of one or more future Asset(s), the end-user places a “bid” on the future Solution/Asset(s). The Bid is an offer from an end-user to purchase the future Solution or Asset(s) at, or below, a set price within a given time frame. The end-user specifies how much he would be willing to pay for a future Solution or Asset(s), essentially stating, “I′m willing to buy ‘X’ for up to ‘$Y’ within the next ‘Z’ weeks (if my bid can be satisfied).” In this example, because of the abstraction supported by Expert-Program modules, ‘X,’ as part of a future Solution, may refer to an abstract “expression of need” as framed by the Expert-Program module, and therefore not to a specific item but rather to any item which may, in future, fulfill this need.

In addition to specifying how much the end-user would pay for a Solution, the end-user also specifies the relevant Criteria, the target values for each Criteria, and the weighted importance values for each Criteria, which may have defaults set by the Author in the Expert-Program module, but perhaps can be modified and refined by the end-user. The end-user may also specify whether he wants the Solution to include only currently existing Assets at improved prices, only Assets that don't yet exist, or a combination thereof. The end-user may further specify when the Bid should begin, how long it should remain active, and how quickly the end-user has to accept or reject the proposed Solution.

However, Bids are only statements of interest, and not a commitment for purchase. Therefore, as part of the Bid process, the end-user next places a deposit on the future Solution, which is a percentage of the Bid amount that is deposited into the end-user's account within their system profile and indicates the degree of the of the end-user's financial commitment to purchasing a future Solution or Asset(s). The end-user is essentially stating, “I'm willing to commit ‘$D’ right now toward this future purchase, if I am able to purchase ‘X’ within ‘Z’ weeks, for ‘$Y’.

Additionally, in yet another embodiment, instead of a deposit, which represents a limited obligation, the end-user may indicate a complete “Commitment” to the future Solution or Assets. A Commitment is a promise and associated obligation to purchase one-or-more Assets (or a Solution), up to a specified price, within a specified time frame. As part of the Commitment, the end-user pays 100% of the Bid price up front. With this option, the end-user is saying, “I will buy ‘X’ for up to ‘$Y,’ within the next ‘Z’ weeks (if my bid can be satisfied).” As with the deposit, the 100% upfront payment is placed in the system and linked to the end-user's profile. The Bid, along with the deposit or Commitment, is saved in the system along with the future Solution and informs the Providers what end-users are willing to pay for the future Solution and Asset(s). As in the prior example, ‘X’ may refer to any item which may, in future, fulfill this need.

Providers and other third parties may then search the Bids in real-time, buy Bids, and fulfill the terms of the Bid by providing the specified Assets (i.e. product(s) and/or service(s)) at or below the Bid price. If the Bid is accepted (bought) by a Provider, the system forwards it to the Provider for fulfillment, as well as the funds of all associated deposits and Commitments. If the Bid is not bought by a provider within its specified time, the Bid expires and the associated deposit or Commitment funds are refunded to the end-user(s) who originally paid them.

In addition, when Bids are purchased, the system can notify the end-user when future Solutions and Asset(s) are available for purchase.

Among the benefits of providing future Solutions is the creation of a new market research portal that can inform Providers as to what Asset(s) end-users want to see in the marketplace and what they are willing to pay for those Assets.

The aspects of the disclosed embodiments are directed to a method executed in a computer-based system using a processor with memory that includes modeling and representing complex problems in memory according to the mechanisms detailed herein, applying information about and/or soliciting information from end-users, and applying the models and expressions of these problems to configure and thereby transform a system in memory to a system capable of efficiently creating and delivering optimized solutions.

In one embodiment, an “end-user” as that term is used herein is regarded as an individual who may represent the interests of another party, including (but not limited to) another individual, a group, or an enterprise, and who represents the interests of the proxied party accordingly. Consistent with this, aspects detailed herein as referring to an end-user, including invocation of the word “personal,” may also (or instead) refer to aspects associated with one-or-more proxied parties.

In one embodiment, the term “problem” as is used hereinis herein regarded as one-or-more circumstances and/or conditions which may be represented (or, using a term of art, “modeled”) via the mechanisms described herein.

In one embodiment, the term “solution” as used herein is herein regarded as one-or-more representations which may satisfy a problem wholly, partially, and to any degree.

In one embodiment, as it relates to solutions, the term “optimization” is contextually associated with and regarded from the perspective of the end-user or group for whom the solution is intended. From this perspective, optimization may relate to any aspect(s) of the solution and/or components therein, including, but not limited to, for example: qualities relating to cost, time, and performance. Solution aspects which may be considered for optimization are unlimited, and may, for example, relate to solutions regarded in part, in whole, individually, and/or in aggregate.

In one embodiment, the problems may be represented, in part or whole, using a declarative expression model which does not compel the end-user to specify the manner and/or exact steps through which an optimal solution should be generated.

In one embodiment, problems may be represented including relationship as an aspect of the model, whereby aspects such as end-users and potential solution-related components may be represented as having condition effects on each other to varying degrees.

In one embodiment, problems may be represented including arbitrary granularity as an aspect of the model, whereby problems may modeled as comprising representations of arbitrary size and/or complexity.

In one embodiment, problems may be represented including connectivity as an aspect of the model, whereby problems may be modeled as having aspects which may conditionally and to varying degrees require interconnection.

In one embodiment, problems may be represented including compatibility as an aspect of the model, whereby problems may be regarded as having aspects which may conditionally and to varying degrees exhibit varying degrees of compatibility.

In one embodiment, problems may be represented including “affinity” and/or “aversion” as an aspect of the model, whereby problems may be regarded as having aspects which may conditionally and to varying degrees exhibit varying degrees of attractive and/or repulsive force.

In one embodiment, aspects including solutions may be represented as comprising sets, each of which may comprise representation of one-or-more goods, services, and/or data components.

In one embodiment, aspects including modeled problems may support contribution from among multiple end-users, such that a solution may reflect the contribution of domain expertise and/or other aspects from many end-users, each of whom may have contributed an arbitrarily granular aspect.

In one embodiment, end-users may continue to evolve and/or refine their contributions, including representations of domain expertise associated with problems, without such modifications necessarily compromising the intended function of these contributions, or “breaking” other dependent aspects.

In one embodiment, problems may be represented including hierarchy as an aspect of the model, whereby problems may be represented as comprised of expressions which are themselves defined by and/or dependent upon successively more-specific expressions, each of which may represent domain expertise or other aspects of the model as described herein.

In one embodiment, the model described herein may be applied to generate optimized solutions in “real-time,” a phrase herein and commonly elsewhere used to describe end-user delays on the order of seconds, during which it remains practical for the end-user to remain engaged in the interactive process of receiving and refining solutions. The real-time solution process thereby supports, in one form of practical usage, iterative end-user engagement, whereby optimized solutions may be repeatedly refined by end-users until perceived by them as ideal.

In one embodiment, the model described herein may be applied to aspects including domain expertise by persons who are not unusually skilled in the arts of computer programming, mathematics, or other domains beyond the expertise they wish to represent. For example, skills and capacity required to model domain expertise such that optimized solutions may be generated by the mechanisms described herein are broadly encompassed by current U.S. high school curriculum requirements.

In one embodiment, problem types may include those for which an optimal solution is represented by: identification and representation of one-or-more best choice(s) among options including goods, services, or datasets.

In one embodiment, problem types may include those for which an optimal solution is comprised of a set of choices.

In one embodiment, problem types may include those for which an optimal solution involves resources which may be constrained, including (but not limited to) fronts such as availability, timing, location, and permissibility.

In one embodiment, problem types may include those which are comprised of other problems, wherein each of the component problems may otherwise have little-or-no apparent relationship with each other, yet may be enjoined to yield a single solution as an expression of optimized satisfaction for the individual problems they collectively represent.

In one embodiment, problem types may include those relating to other processes and/or dynamic systems which are driven and/or bound, in part or whole, by resources and/or constraints including but not limited to, for example, time, space, and money. Examples of such systems include (but are not limited to) businesses, markets, and agricultural and industrial processes.

In one embodiment, optimized solutions may include representations of one-or-more goods and/or services (“future Assets”) not known to exist with the combination of characteristics (e.g. price, availability) represented therein, or not known to exist at all beyond representation within the optimized solution generated by the processes described herein but which, if existent with such characteristics, would contribute to the representation of an optimal solution. Solutions including future Assets are future solutions.

In one embodiment, end-users may commit to the purchase of future Assets via future solutions, such commitments including (but not limited to) present payment and/or the promise of future payment toward partial or complete payment for purchase of future Assets. Because future Assets within future solutions may not yet exist, a market is created in which one-or-more items which are not yet fully-defined or fully-known to the buyer may be purchased.

In one embodiment, the market for future Assets creates a secondary market in which parties (including but not limited to creators and/or sellers of goods and/or services) can know with certainty that a particular good and/or service with specific characteristics (including but not limited to features such as cost) will sell once it is created or so characterized.

In one embodiment, the market for future Assets enables parties (including but not limited to creators and/or sellers of goods and/or services) to easily and efficiently determine the hypothetical present value of future assets and/or individual specifications and/or characteristics and/or features in accordance with the correlation between hypothetical changes to specification(s) and projected results including (but not limited to) consequences such as changes in sales volume. Accordingly, parties such as manufacturers and retailers may design or alter goods and/or services in such a manner as to maximize profit associated with the sale of these goods/services.

In one embodiment, a quality herein called “primacy” is established between an individual end-user or group and the items (e.g. goods, services, and datasets) they regard, reflecting the comparative degree to which these items are suitable for them based on characteristics inherent in and specific to both the items themselves and the end-user or collection of users regarding them.

In one embodiment, a process accurately predicts primacy based on specific items and individual end-users or groups for whom primacy has not yet been established.

In one embodiment, data used by end-users (such as motivations, preferences and considerations) and acted upon in the service of specific decisions (such as a purchase) is obtained from end-users. Such data is fully contextualized (e.g. associated with a particular item, category, and/or circumstance), reflecting relative importance, and one-or-more preferred values, choices, and/or ranges. This data serves as a uniquely accurate representation of (potentially purchase-related) end-user drives, and may have no apparent or direct correlation with specifications and/or characteristics associated with the goods and/or services that might satisfy these drives.

The invention can be implemented in digital electronic circuitry, or in computer hardware, firmware, software, or in combinations of them. The invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

While the invention has been described in terms of several preferred embodiments, it should be understood that there are many alterations, permutations, and equivalents that fall within the scope of this invention. It should also be noted that there are alternative ways of implementing both the process and apparatus of the present invention. For example, steps do not necessarily need to occur in the orders shown in the accompanying figures, and may be rearranged as appropriate. It is therefore intended that the appended claim includes all such alterations, permutations, and equivalents as fall within the true spirit and scope of the present invention.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of this disclosure (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., such as, preferred, preferably) provided herein, is intended merely to further illustrate the content of the disclosure and does not pose a limitation on the scope of the claims. No language in the specification should be construed as indicating any non-claimed element as essential to the practice of the present disclosure.

Multiple embodiments are described herein, including the best mode known to the inventors for practicing the claimed invention. Of these, variations of the disclosed embodiments will become apparent to those of ordinary skill in the art upon reading the foregoing disclosure. The inventors expect skilled artisans to employ such variations as appropriate (e.g., altering or combining features or embodiments), and the inventors intend for the invention to be practiced otherwise than as specifically described herein.

Accordingly, this invention includes all modifications and equivalents of the subject matter recited in the claims appended hereto as permitted by applicable law. Moreover, any combination of the above described elements in all possible variations thereof is encompassed by the invention unless otherwise indicated herein or otherwise clearly contradicted by context.

The use of individual numerical values are stated as approximations as though the values were preceded by the word “about” or “approximately.” Similarly, the numerical values in the various ranges specified in this application, unless expressly indicated otherwise, are stated as approximations as though the minimum and maximum values within the stated ranges were both preceded by the word “about” or “approximately.” In this manner, variations above and below the stated ranges can be used to achieve substantially the same results as values within the ranges. As used herein, the terms “about” and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors which may be considered include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about” or “approximately” will serve to broaden a particular numerical value or range. Thus, as a general matter, “about” or “approximately” broaden the numerical value. Also, the disclosure of ranges is intended as a continuous range including every value between the minimum and maximum values plus the broadening of the range afforded by the use of the term “about” or “approximately.” Thus, recitation of ranges of values herein are merely intended to serve as a shorthand method of referring individually to each separate value falling within the range, unless otherwise indicated herein, and each separate value is incorporated into the specification as if it were individually recited herein.

It is to be understood that any ranges, ratios and ranges of ratios that can be formed by, or derived from, any of the data disclosed herein represent further embodiments of the present disclosure and are included as part of the disclosure as though they were explicitly set forth. This includes ranges that can be formed that do or do not include a finite upper and/or lower boundary. Accordingly, a person of ordinary skill in the art most closely related to a particular range, ratio or range of ratios will appreciate that such values are unambiguously derivable from the data presented herein.

What is claimed is:

1. A system for creating and delivering an optimized solution to a complex problem, comprising:
a controller with a memory in communication with a processor, the memory including program instructions for execution by the processor to:
detect an input of a search query, the search query containing one or more information elements that describe the complex problem;
identify an expert program module corresponding to the search query, the expert program module configured to define and specify a set of rules and relationships in a hierarchical manner that are associated with the search query to provide a criteria-based solution model;
a solution module configured to interface with the expert program module and apply user generated criteria and relationships to the model and represent the complex problem in memory using one or more mechanisms that relate relationships, importances and data values in a hierarchical manner and generate the optimized solution to the complex problem; and
a database that stores information on currently available assets that are included in the optimized solution.

2. The system of claim 1, comprising a user interface configured to enable an input of the search query.

3. The system of claim 1, wherein the expert program module includes program instructions for execution by the processor to identify one or more user selectable criteria related to the search query, enable selection of one or more of the user selectable criteria, and apply the selected criteria to the search query.

4. The system of claim 3, wherein the expert program module includes program instructions for execution by the processor to weight the selected criteria based on a level of importance value.

5. The system of claim 4, wherein the expert program module includes program instructions for execution by the processor to apply the set of rules and relationships to the selected criteria and generate a criteria modeled search query.

6. The system of claim 5, wherein the solution module includes program instructions for execution by the processor to receive the criteria modeled search query from the expert module and identify one or more assets from the database that correspond to a solution to the complex problem corresponding to the search query.

7. The system of claim 1, wherein the rules and relationships of the expert program module corresponding to specific subject matter areas.

8. The system of claim 1, wherein the expert program module comprises information element blocks, each information element block storing data pertaining to a subject matter area.

9. The system of claim 1, wherein the solution module includes program instructions for execution by the processor to represent the optimized solution as a set of data, the set of data comprising representations of one or more of goods, services and data components.

10. A method executed in a computer-based system using a processor with a memory, the method comprising:
modeling and representing a complex problem in the memory using mechanisms to describe relationships, importances, and data values in a hierarchical manner;
applying the mechanisms to descriptive criteria associated with assets that include goods, services, people and data;
generating one or more optimized solutions to the problem which may include the assets or allocations of the assets; and
delivering one or more of the optimized solutions to an end-user.

11. The method of claim 10, comprising incorporating information about the end-user that is received from a data store or interactively solicited from the end user, and using the information to optimize the solutions.

12. The method of claim 10, wherein the modeling and representing of the complex problem comprises applying a set of criteria to the complex problem, the set of criteria being pre-defined and including rules and relationships pertaining to a subject matter of the complex problem.

13. The method of claim 12, wherein the set of criteria comprises a relationship model linking assets to characteristics of those assets.

14. The method of claim 12, wherein the set of criteria comprises data that defines personal preferences of the end-user corresponding to the assets.

15. The method of claim 14, where generating one or more optimize solutions comprises applying the model of the complex problem to a database of assets to identify one more assets that satisfy the complex problem.

16. The method of claim 10, wherein the modeling and representing of the complex problem comprises:
parsing a search query and matching the search query to a subject matter module in a database of subject matter modules; and
applying a set of pre-defined rules stored in the subject matter module to the search query and quantifying a set of asset selection criteria associated with the search query.

17. The method of claim 16, wherein applying the pre-defined set of rules comprises identifying connections and interconnections between assets associated with the search query.

18. The method of claim 16, wherein applying the pre-defined set of rules comprises correlating a compatibility of an asset with a descriptive criteria associated with the asset.

19. The method of claim 16, wherein applying the pre-defined set of rules comprises identifying affinities of assets identified as being relevant to the complex problem.

20. A computer program product for creating and delivering an optimized solution to a complex problem, the computer program product comprising computer readable code means, the computer readable program code means when executed in a processor device, being configured to execute the method steps recited in claim 10.
